(19) United States
(12) Patent Application Publication
(10) Pub. No.: US 2026/0169871 A1
(43) Pub. Date: Jun. 18, 2026

(54) ENCODING SCHEMES FOR REDUNDANT SYSTEMS

(71) Applicant: Volantis Semiconductor Inc., Portland, OR (US)

(72) Inventor: Tapabrata Ghosh, Oakland, CA (US)

(73) Assignee: Volantis Semiconductor Inc., Portland, OR (US)

(21) Appl. No.: 18/981,269

(22) Filed: Dec. 13, 2024

(51) Int. Cl. G06F 11/20; G06F 11/14

(52) U.S. Cl. CPC G06F 11/202; G06F 11/1443

(57) ABSTRACT

An apparatus comprising a plurality of processors coupled with a plurality of interconnects, e.g., sets of principle and redundant interconnects, to transmit/receive signals between the plurality of processors using one or more encoding schemes (e.g., first and second encoding schemes) based on an indication associated with the plurality of processors. The indication may manifest as a change in logic levels, e.g., first and second logic levels, where the first and second logic levels are different. The first encoding scheme signals over some but not all the sets of redundant interconnects based on the indication being the first logic level. The second encoding scheme signals over the set of principle interconnects and the set of redundant interconnects based on the indication being the second logic level, wherein the second encoding scheme is a one-hot encoding scheme.

### BACKGROUND

One way to handle faults is to build redundancy in the architecture. For example, redundant processors can be added to a group of main processors to mitigate situations where any one of the main processors is declared non-functional. Redundancy comes with cost of redundant dies, interconnects, drivers and receivers for those interconnects, etc. As such, redundancy presents lost opportunity cost when no failure occurs.

The background description provided here is for the purpose of generally presenting the context of the disclosure. Unless otherwise indicated here, the material described in this section is not prior art to the claims in this application and are not admitted to be prior art by inclusion in this section.

### BRIEF DESCRIPTION OF DRAWINGS

The examples will be understood more fully from the detailed description given below and from the accompanying drawings, which, however, should not be taken to limit the disclosure to the specific examples, but are for explanation and understanding only.

FIG. 1 is a schematic of a wafer-level assembly of groups of chiplets on a substrate with one or more bridge dies and one or more embedded interconnects, in accordance with at least one example.

FIG. 2 is a top-view schematic of a wafer-level assembly of groups of chiplets on a substrate with one or more bridge dies and one or more embedded interconnects, in accordance with at least one example.

FIG. 3 is an alternate schematic of a wafer-level assembly of groups of chiplets on a substrate with one or more bridge dies and one or more embedded interconnects, in accordance with at least one example.

FIG. 4A is a schematic of a wafer-level assembly of multi-core processors in a fully connected configuration with one or more interconnects, in accordance with at least one example.

FIG. 4B is a schematic of a multi-core processor with a plurality of bridge dies, in accordance with at least one embodiment.

FIG. 4C is a schematic of a multi-core processor with integrated interconnect pathways, in accordance with at least another embodiment.

FIG. 5A is a schematic of a wafer-level assembly of groups of chiplets, connected in a fully-connected torus configuration with one or more interconnects, in accordance with at least one example.

FIG. 5B is a schematic of fully-connected configuration with one or more interconnects, in accordance with at least one example.

FIG. 6A is a schematic of a wafer-level assembly of groups of chiplets connected in a fat-tree torus configuration with one or more interconnects, in accordance with at least one example.

FIG. 6B is a schematic of fat-tree configuration with one or more interconnects, in accordance with at least one example.

FIG. 7 is a schematic of a three-dimensional (3D) architecture of a wafer-level assembly of groups of chiplets connected in a 3D torus configuration by through-silicon via (TSV), in accordance with at least one example.

FIG. 8A is a schematic of a wafer-level assembly of multi-core processors with redundancy and employment of one or more encoding schemes, in accordance with at least one example.

FIG. 8B is a schematic of a multi-core processor with redundancy and employment of one or more encoding schemes, in accordance with at least one example.

FIG. 9 is a schematic of a group of chiplets including different types of chiplets in a wafer-level assembly of chiplets, in accordance with at least one example.

FIG. 10 is a schematic of a chiplet having functionality of a graphics processing unit (GPU), in accordance with at least one example.

FIG. 11 is a schematic of a chiplet having functionality of a memory module, in accordance with at least one example.

FIG. 12 is a flowchart of a method of detection of an indication (e.g., fault) and switching encoding scheme based on the indication, in accordance with at least one example.

### DETAILED DESCRIPTION

Disclosed herein are one or more encoding schemes to transmit signals within a family of network topologies and their application to systems such as wafer-scale systems, a processor, a group of processors, and a group of processor cores in a processor, especially with regards to efficient redundancy methods. To maintain redundancy in a system, redundant chiplets may be used in the family of network topologies to ensure reliability and fault tolerance. The chiplets may also use extra wiring or interconnects to facilitate communication based on an indication (e.g., fault), in accordance with at least one example. In at least one example, extra wiring or interconnects (e.g., redundant interconnects) can be utilized alongside a set of principle interconnects to send and receive signals even in the absence of a fault. In at least one example, the system can employ a first encoding scheme or a second encoding scheme based on an indication. An indication of a first logic level can result in application of the first encoding scheme that sends and/or receives signal over some but not all sets of redundant interconnects. An indication of a second logic level can result in application of the second encoding scheme that sends and/or receives signal over the set of principle interconnects and the set of redundant interconnects. In at least one example, the first logic level is different from the second logic level.

In at least one example, the first encoding scheme is a binary encoding scheme, which uses fewer bits by representing data as binary numbers. In at least one example, the first encoding scheme is a traditional encoding scheme that may use fewer wires and may have a high transition probability. In at least one example, the first encoding scheme is also wire efficient, e.g., the first encoding scheme makes use of fewer wires. In at least one example, the second encoding scheme is a one-hot encoding scheme that may signal using one-hot bit to reduce the transition probability and thus the transition energy. In at least one example, the one-hot encoding scheme may represent discrete values or data as binary vectors. In at least one example, the system can send and/or receive bits over double the number of wires needed to send and/or receive the same number of bits, based on the indication of the second logic level. In at least one example, the second encoding scheme is wire inefficient, e.g., the second encoding scheme may use more channels or signal lines, decreasing dynamic power consumption.

In at least one example, chiplets or dies within a family of network topologies are processors or processor cores. In at least one example, chiplets or dies within a family of network topologies function as encoders. In at least one example, encoders are a part of a communication interface of processors or processor cores, where the encoders can facilitate the transmission of signals between the processors or the processor cores via the set of principle interconnects and the set of redundant interconnects. In at least one example, chiplets or dies within a family of network topologies can be functionally similar. In at least one example, chiplets or dies within a family of network topologies are functionally different from each other. In at least one example, the family of network topologies is a hierarchical topology, where an intra-group topology is not a mesh or torus, and where an inter-group topology is a mesh or torus. In at least one example, the intra-group topology is a fully-connected topology, and the inter-group topology is a mesh or torus. In at least one example, the intra-group topology is a fat-tree topology, and the inter-group topology is a mesh or torus topology.

Here, “chiplet” or “dielet” may generally refer to an Integrated Circuit (IC) or a die that is designed to operate as a part of a larger system-on-chip (SoC) architecture. Instead of creating a complete custom chip from scratch, manufacturers can use multiple chiplets or dies, each designed for specific functions, and integrate them into a single package or die. Chiplets allow for modular design, which can improve efficiency and reduce manufacturing costs. This approach also provides flexibility, as different chiplets can be combined in various configurations to meet the demands of different applications. Chiplets can provide various functions, including processing cores, memory controllers, or specific I/O functionalities. Chiplets can be used in high-performance computing and edge devices, as they enable quicker time-to-market and the ability to mix and match to create optimized solutions.

Here, “die” may generally refer to a single continuous piece of semiconductor material (e.g. silicon) where transistors or other components which make up a processor core may reside. Multi-core processors may have two or more processors on a single die, but alternatively, the two or more processors may be provided on two or more respective dies. In at least one example, dies are of the same size and functionality i.e., symmetric cores. In at least one example, dies are asymmetric. For example, some dies have different size and/or function than other dies.

Here, “interconnects” may generally refer to electrical wiring either of or in integrated circuits that facilitates communication between different components, e.g., chiplets, dielets, dies, nodes, processors, circuits, or functional blocks. An interconnect may be a communication link between two or more components or nodes. Interconnects can enable the transfer of signals, data, and power across a system, ensuring that components can effectively work together. The configuration of interconnects significantly influences the performance, speed, and reliability of the overall circuit. Interconnects can include conduction paths such as a fabric, passive or active components, wires, vias, waveguides, fiber optics, etc.

Here, “principle interconnects” generally refers to the main pathways that connect the functional components of a system. Principle interconnects handle the bulk of data transmission and are designed to provide a high bandwidth and a low latency. Principle interconnects typically include through-silicon vias (TSVs), solder micro bumps, and standard metal traces, which are optimized for performance under normal operating conditions. In the absence of redundant interconnects, principle interconnects provide the main and normal pathways between circuits of a system.

Here, “redundant interconnects” generally refers to backup pathways that activate when circuits associated with principle interconnects or when principle interconnects themselves fail due to faults, environmental factors, or manufacturing defects. Redundant interconnects provide backup or redundant pathways that enhance the resilience of the system by ensuring that communication can continue even in the event of a failure associated with the principle interconnects. By incorporating redundant interconnects with nodes in a system, the system can maintain connectivity and functionality, thus reducing the risk of complete operational loss.

Here, “interconnect fabric” or “fabric” may generally refer to communication mechanism having a known set of sources, destinations, routing rules, topology, and other properties. The sources and destinations may be any type of data handling functional unit. A fabric may be part of a network-on-chip (NoC) with multiple agents. These agents can be any functional unit. Fabrics can be two-dimensional spanning along an x-y plane of a die or chiplet and/or three-dimensional (3D) spanning along an x-y-z plane of a stack of vertical and horizontally positioned dies. A single fabric may span multiple dies. A fabric can take any topology such as mesh topology, fat-tree, dragonfly, star topology, daisy chain topology, etc.

In the following description, numerous details are discussed to provide a more thorough explanation of examples of the present disclosure. It will be apparent, however, to one skilled in the art, that examples of the present disclosure may be practiced without these specific details. In other instances, well-known structures and devices are shown in block diagram form, rather than in detail, to avoid obscuring examples of the present disclosure.

Note that in the corresponding drawings of the examples, signals are represented with lines. Some lines may be thicker, to indicate multiple constituent signal paths, and/or have arrows at one or more ends, to indicate primary information flow direction. Such indications are not intended to be limiting. Rather, the lines are used in connection with one or more exemplary examples to facilitate easier understanding of a circuit or a logical unit. Any represented signal, as dictated by design needs or preferences, may actually comprise one or more signals that may travel in either direction, and may be implemented with any suitable type of signal scheme, particularly those communication schemes described herein.

It is pointed out that those elements of the figures having the same reference numbers (or names) as the elements of any other figure can operate or function in any manner like that described but are not limited to such.

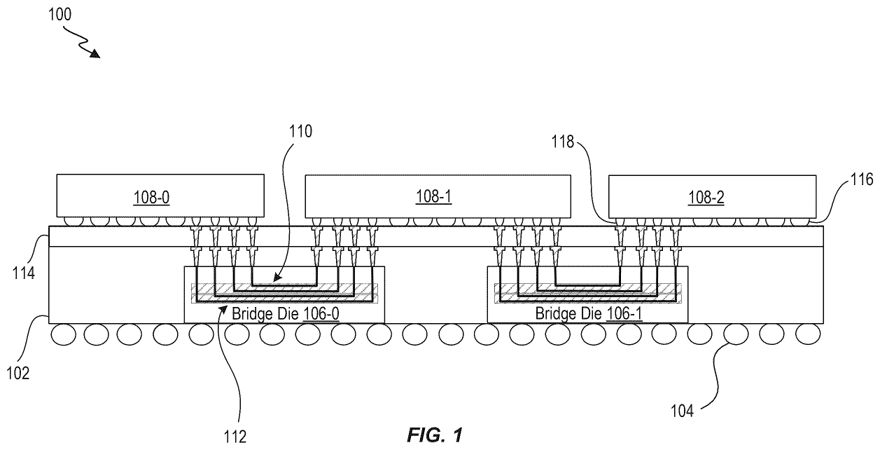

FIG. 1 is a schematic of a wafer-level assembly of groups of chiplets 100 on a substrate with one or more bridge dies, embedded with one or more interconnects, in accordance with at least one example. For a system such as a wafer-scale system where chiplets are bonded to create a larger than reticle assembly, the bonding of chiplets to a substrate or other chiplets can fail due to systematic failures causing all bumps in a chiplet to fail to bond, or from many individual bump failures. When this happens, the wafer-scale assembly may become useless and may have to be discarded. To mitigate these challenges, redundancy schemes are implemented within wafer-scale systems. The redundancy schemes not only enhance reliability of wafer-scale systems but can also reduce the likelihood of discarding entire assemblies, especially when failures are localized, ultimately improving yield.

In conjunction to the bonding of chiplets on a substrate, interconnections between chiplets play a significant role in facilitating communication across the wafer-scale systems. The interconnections are meticulously designed and manufactured on the substrate, employing advanced techniques such as microfabrication and bonding processes. This allows for a dense arrangement of wiring, which not only connects the primary interconnects but also incorporates redundant interconnects to ensure that the entire wafer-scale system maintains a robust connectivity in the event of a fault. The integration of redundant interconnects ensures that if the primary interconnects fail, e.g., due to a fault, environmental factors, or manufacturing defects, the groups of chiplets can seamlessly continue communications on the backup paths to provide high availability, data integrity, and system performance. However, with continuously improving reliability of chiplets, in many cases the redundant interconnects remain unused that can potentially lead to a waste of wiring resources (e.g., if no fault is detected to activate the redundant interconnects). Therefore, additional unused wiring resources may present themselves as unused resources.

Described herein is a method and apparatus to effectively utilize the additional unused wiring resources (e.g., redundant interconnects) to carry electrical signals during normal operations (e.g., when no fault occurs). At least one example discloses a hierarchical network topology that provides redundancy efficiently, allowing the wafer-scale systems to reroute functions to operational chiplets in the event of failures, and allowing the wafer-scale system to signal over double the number of wires using only one-hot bit to reduce transition probability in the absence of failures.

While various examples herein are described with reference to wafer-scale systems, the examples are applicable to a processor with multiple processor cores including redundant processor cores and interconnects, and to a processor system with multiple processor dies including redundant processor dies and interconnects.

The wafer-level assembly of groups of chiplets 100 can house multiple groups of chiplets 108-0, 108-1, 108-2 within a single substrate, which can be collectively referred to as groups of chiplets 108, and can be individually referred to as group of chiplets 108. An individual group of chiplets 108 can be fabricated on a silicon wafer using semiconductor manufacturing techniques, such that chiplets within groups of chiplets 108 can operate independently and can also communicate effectively with neighboring chiplets within groups of chiplets 108. Groups of chiplets 108 are assembled onto substrate 102, wherein substrate 102 may support power distribution and thermal management.

In at least one example, chiplets within group of chiplets 108 are interconnected via bridge dies that may be surrounded or embedded in substrate 102. Bridge dies such as 106-0, 106-1 . . . can be collectively referred to as bridge dies 106, and can be individually referred to as bridge die 106. One such example is illustrated by FIG. 1, where groups of chiplets 108 may be mounted onto substrate 102 using solder bumps 116 and solder micro bumps 118. Group of chiplets 108-0 is interconnected to group of chiplets 108-1 which is interconnected to group of chiplets 108-2 through electrical vias which may be present in a redistribution layer (RDL) 114 within substrate 102.

In at least one example, vias extend to bridge dies 106, which are equipped with conductive routing traces (e.g., interconnects) that may be coupled to the chiplets within group of chiplets 108. In at least one example, bridge dies 106 may include drivers and switches to route signals from one end to another end by means of one or more interconnects. In at least one example, bridge dies 106 are programmable dies that can be programmed by hardware (e.g., fuses) or software, or a combination thereof.

In at least one example, bridge dies 106 can establish electrical connections between different chiplets or dies in a vertically stacked or horizontally integrated configuration. In at least one example, bridge dies 106 serve as an intermediary to reduce the distance electrical signals need to travel, improving bandwidth and reducing latency. In at least one example, bridge dies 106 can also provide interconnection outside of substrate 102 through solder bumps 116 or package interface 104. In at least one example, bridge dies 106 provide a low-resistance path for signals between chiplets to maintain signal integrity and reduce losses. In at least one example, bridge dies 106 can assist in dissipating heat across multiple chiplets, serving as a thermal interface. This helps manage heat more efficiently in wafer-level assembly of chiplet architectures.

In at least one example, in a wafer-level scaling architecture, multiple types of dies (e.g., analog, digital, RF chiplets) can be integrated using bridge dies 106, allowing for enhanced functionality and performance. This may be particularly valuable in applications that use diverse processing capabilities, such as internet-of-things (IoT) devices or mobile applications. In at least one example, bridge dies 106 allows for a more compact design by reducing the overall footprint of the wafer-level assembly. For instance, by layering dies and connecting them with bridge dies 106, manufacturers can save significant space on substrate 102.

By integrating bridge dies 106 at the wafer level, manufacturers can achieve higher yields and better cost efficiency. Defects in one die or chiplet can be mitigated by the presence of bridge dies 106, allowing the use of more dies from the same wafer assembly as replacement of the defective die(s) or chiplet(s). The inclusion of bridge dies 106 provides designers with a better flexibility of design, enabling a modular approach to building complex systems. This allows for easier upgrades or changes in design over time.

Bridge dies 106 can be used with any wafer-level assembly of chiplets discussed herein. While FIG. 1 partially illustrates bridge die 106-0 connecting various chiplets within group of chiplets 108-0 and group of chiplets 108-1, another bridge die 106-1 connects various chiplets of group of chiplets 108-1 with chiplets of another group of chiplets 108-2. Similar bridge dies can be used to couple more groups of chiplets. In at least one example, every two groups of chiplets can share a bridge die. In at least one example, every four groups of chiplets can share a bridge die. In other examples, any number of the groups of chiplets share a bridge die.

In at least one example, bridge dies 106 may comprise multiple layers, where an individual layer can feature intricate interconnects or fabrics for signaling. A layered bridge die can enhance connection density and can further reduce signal latency. One such example is illustrated by FIG. 1, where bridge dies 106 may include two or more layers for embedding one or more interconnects. In at least one example, a top layer of a bridge die 106 may comprise a set of principle interconnects 110 and a bottom layer of bridge die 106 may comprise a set of redundant interconnects 112. In at least one example, the top layer may comprise set of redundant interconnects 112 and the bottom layer may comprise set of principle interconnects 110. In at least one example, the top layer may comprise set of principle interconnects 110 and set of redundant interconnects 112 to interconnect a first chiplet in a first group of chiplets 108-0 to a first chiplet in a second group of chiplets 108-1, and a second chiplet of the first group of chiplets 108-0 to a second chiplet of the second group of chiplets 108-1.

In at least one example, the bottom layer may comprise set of principle interconnects 110 and set redundant interconnects 112 to interconnect a third chiplet of the first group of chiplets 108-0 to a third chiplet of third group of chiplets 108-2, and a fourth chiplet of first group of chiplets 108-0 to a fourth chiplet of third group of chiplets 108-2. Here, the bridge die is shared by three groups of chiplets, but the examples are not limited to such. In at least one example, every two groups of chiplets can share a bridge die. In at least one example, every four groups of chiplets can share a bridge die. In other examples, any number of groups of chiplets may share a bridge die.

In at least one example, groups of chiplets 108 can function as individual chiplets that are mounted on substrate 102 to form a single chip. In at least one example, the individual chiplets are processor cores that may act as separate processors within the single chip. In at least one example, groups of chiplets 108 can function as multiple single chips that are mounted onto substrate 102, creating a multi-chip assembly. In at least one example, each individual chip within the multi-chip assembly includes multiple processor cores, e.g., an individual chip may act as a multi-core processor. In at least one example, processors or processor cores can be individual chiplets within groups of chiplets 108. In at least one example, chiplets in groups of chiplets 108 may function as encoders. In at least one example, encoders can be part of a communication interface of processors or processor cores that can facilitate the transmission of signals between the processors or the processor cores via set of principle interconnects 110 and set of redundant interconnects 112. In at least one example, chiplets in a group of chiplets can also be functionally similar. In at least one example, chiplets in a group of chiplets 108 can be functionally different from each other. For example, a chiplet may be a microprocessor, a graphics processor unit (GPU), a local area network (LAN) port, a double data rate (DDR) based random access memory (RAM), etc., or a combination of them.

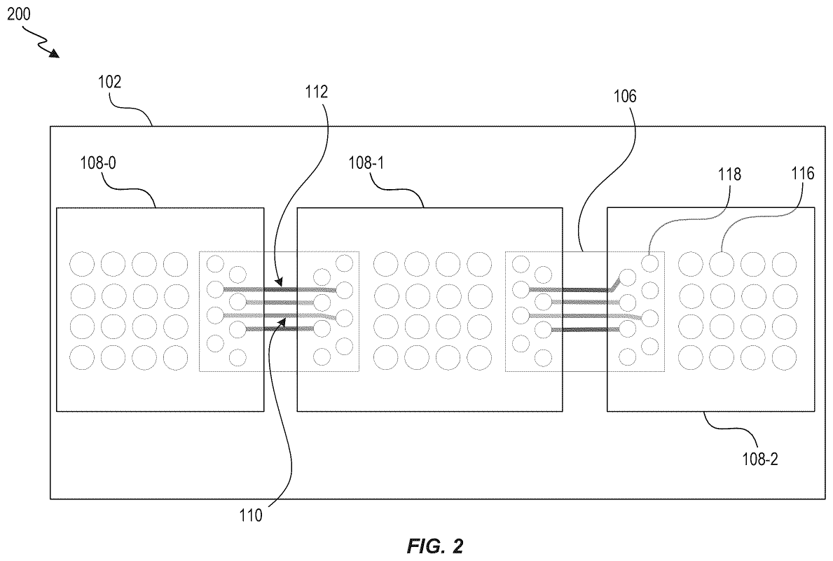

FIG. 2 is a top-view schematic of a wafer-level assembly of groups of chiplets 200 on a substrate with one or more bridge dies, embedded with one or more interconnects, in accordance with at least one example. Substrate 102 incorporates solder bumps 116 and solder micro bumps 118, wherein solder bumps 116 may provide connection pathways between chiplets of groups of chiplets 108 and substrate 102 to make primary connections (e.g., to power supply VCC, ground VSS, or the like). In at least one example, solder micro bumps 118 may provide connection pathways between chiplets of groups of chiplets 108 and bridge dies 106, that may allow electrical signals to travel from the first chiplet in first group of chiplets 108-0 to the first chiplet in second group of chiplets 108-1 via set of principle interconnects 110 or set of redundant interconnects 112 embedded within bridge die 106-0. In at least one example, electrical signals can travel from second group of chiplets 108-1 to third group of chiplets 108-2 through electrical vias embedded within RDL layer 114, and through set of principle interconnects 110 and set of redundant interconnects 112 embedded within bridge die 106-1.

In at least one example, groups of chiplets 108 can be interconnected via bridge dies, wherein bridge dies 106 may include drivers and switches to route signals from one end to another end of groups of chiplets 108. Drivers in bridge dies 106 can handle low-level interactions, which may ensure that data is properly transmitted and received across the communication pathways. In at least one example, switches can direct the flow of signals within the interconnect network e.g., over the set of principle interconnects 110 and/or set of redundant interconnects 112. In many systems, bridge dies 106 are programmable components that can be configured through hardware mechanisms, such as fuses, or via software, or even a combination of both. The programmable components can allow for a flexible management of data routing and network configurations within bridge dies 106.

In at least one example, an operating system which may be managed by the drivers in bridge dies 106 can generate an indication. In at least one example, an operating system can be executed on chiplets to manage processes and collaborate with other chiplets in a group of chiplets 108. The indication may come from one or more logic units associated with the chiplets or group of chiplets 108, in accordance with at least one example. In at least one example, the indication can be a binary indication that may be generated based on logic levels, either zero (0) or one (1). One such example is illustrated here where an indication may manifest as a change in the logic levels. In at least one example, the operating system can make decisions based on the indication, wherein the operating system can be stored on chiplets, groups of chiplets 108, or bridge dies 106.

In at least one example, the operating systems or the logic units can employ a first encoding scheme or a second encoding scheme based on the indication. The indication of first logic level can result in employment of the first encoding scheme that sends and/or receives signals over some but not all sets of redundant interconnects 112. The indication of a second logic level can result in employment of the second encoding scheme that sends or receives signal over set of principle interconnects 110 and set of redundant interconnects 112. In at least one example, the second encoding scheme is a one-hot encoding scheme. In at least one example, the first logic level can be 1 and the second logic level can be 0. In at least one example, the first logic level can be 0 and the second logic level can be 1. In at least one example, the first logic level may be different from the second logic level.

The indication of the first logic level can be based on anomalies e.g., signal errors or degraded performance. In at least one example, the indication of the first logic level may be generated based on overheating, such that chiplets within groups of chiplets may run above an optimal temperature range which may lead to thermal damage. In at least one example, voltage drops or power fluctuations may generate an indication of the first logic level. In at least one example, latency issues in the communication paths may generate an indication of the first logic level. In at least one example, hardware faults such as chiplets failure or connectivity issues may trigger an indication of the first logic level. In at least one example, an indication of the second logic level is to operate the system in a high-performance mode (e.g., turbo mode), where resources can be fully utilized. For example, if the operating system detects no anomaly, the operating system may switch to turbo mode, which represents an operational state designed for power efficiency and noise tolerance. In at least one example, the indication of the second logic level may also be operation specific.

In at least one example, the first encoding scheme can be a parallel interface, that can signal over a defined set of redundant interconnects (e.g., the set of redundant interconnects with an indication of the first logic level). Signals can be applied over the signal lines of the defined set of redundant interconnects 112, wherein each of the sets of redundant interconnects may serve as a channel for one or more bits of data, in accordance with at least one example. For example, to transmit data, each bit of data can be encoded into electrical signals associated with various voltage levels, typically a high voltage representing one (active) and a low voltage representing zero (inactive). In at least one example, the first encoding scheme can have a high transition probability. In some cases, the first encoding scheme can have multiple bits that may be set to the high voltage, all corresponding signal lines of set of redundant interconnects 112 may draw more power to maintain the active states. Furthermore, as the number of active bits may increase, dynamic power consumption may significantly increase as more channels or signal lines may be simultaneously engaged.

In at least one example, unlike the first encoding scheme, the second encoding scheme can be a one-hot encoding scheme. One-hot encoding scheme can have one bit active at any given time, while all other bits are inactive. Based on an indication of the second logic level, the second encoding scheme can apply signals over sets of principle interconnects 110 and sets of redundant interconnects 112, in accordance with at least one example. In at least one example, the second encoding scheme can have a low transition probability. The second encoding scheme may have one bit that may be set to the high voltage and can draw voltage to maintain the active state, all other signal lines of set of principle interconnects 110 and set of redundant interconnects 112 may not be engaged (e.g., are tri-stated, driven by a known signal (e.g., Vss), etc.). Thus, the second encoding scheme may use more channels or signal lines, but dynamic power consumption may significantly decrease, in accordance with at least one example.

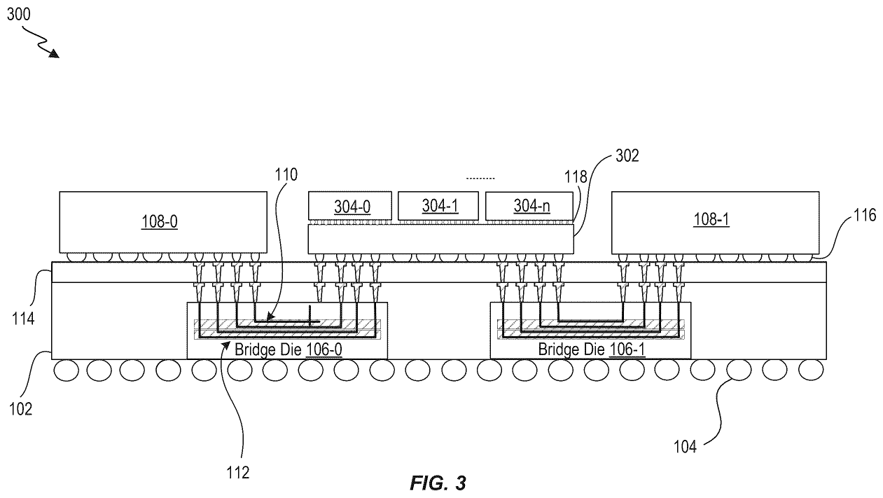

FIG. 3 is an alternate schematic of a wafer-level assembly of groups of chiplets on a substrate with one or more bridge dies and one or more embedded interconnects, in accordance with at least one example. The alternate wafer-level assembly of group of chiplets 300 can house multiple groups of chiplets within the substrate 102, wherein group of chiplets 108-0 and 108-1 can be processors, in accordance with at least one example. In at least one example, processors or processor cores can be individual chiplets 304-0, 304-1, . . . , 304-n within a group of chiplets mounted on a base die 302. In at least one example, base die 302 may serve as a foundation layer that can provide support and provide connections for individual chiplets 304-0, 304-1, . . . , 304-n, mounted on base die 302. In at least one example, individual chiplets 304 may be referred to as dies that can be horizontally placed in a multi-die configuration on base die 302. In at least one example, individual chiplets 304 or dies mounted on base die 302 can serve as a single chip. The wafer-level assembly can house multiple single chips within substrate 102, in accordance with at least one example.

In at least one example, groups of chiplets or base dies may be interconnected via bridge dies 106 that may be surrounded or embedded in substrate 102. One such example is illustrated by FIG. 3, where chiplet 108-0, chiplet 108-1 or base die 302 may be mounted onto substrate 102 using solder bumps 116 and solder micro bumps 118. In at least one example, individual chiplets 304-0, 304-1, . . . , 304-n may be mounted on base die 302 using solder micro bumps 118. Solder bumps 116 can provide electrical connectivity to base die 302 by establishing direct connections with the substrate 102. In at least one example, solder micro bumps 118 can be employed to mount individual chiplets 304-0, 304-1, . . . , 304-n onto base die 302, to provide high density connections. In at least one example, base die 302 can provide integrated interconnect pathways, such as metal traces or electrical vias, which can route signals between individual chiplets 304. In at least one example, bridge dies can be incorporated into base die 302 to provide connections between individual chiplets 304.

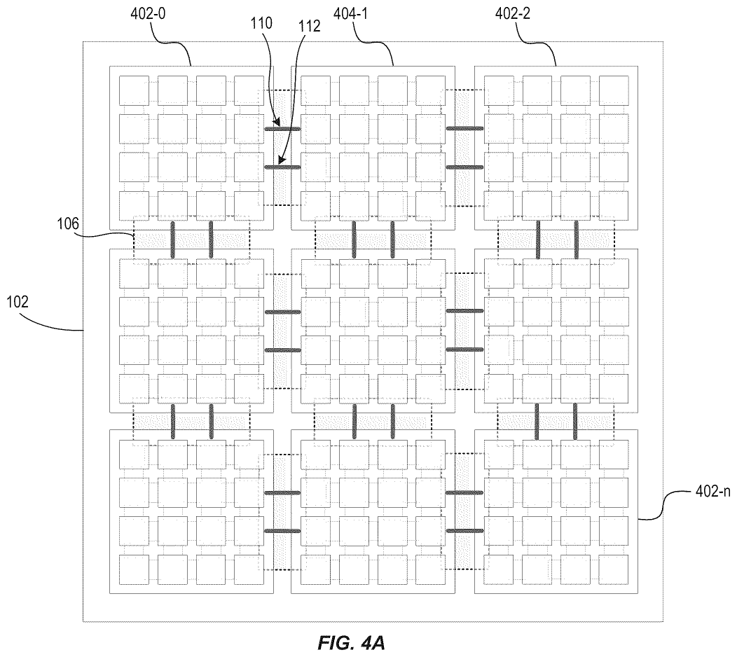

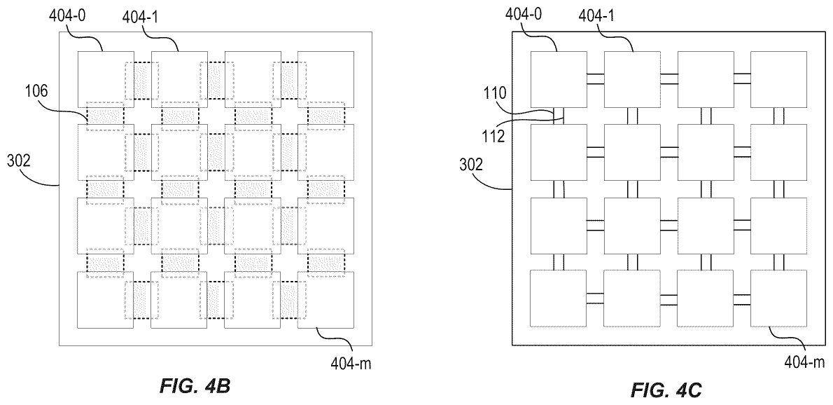

FIG. 4A is a schematic of a wafer-level assembly of multi-core processors in a fully connected mesh configuration, in accordance with at least one example. The wafer-level assembly of the multi-core processors includes a plurality of multi-core processors 402-0, 402-1, 402-2, . . . , 402-n, which can be collectively referred as processors 402 or multi-core processors 402 and can be individually referred to as processor 402 or multi-core processor 402. In at least one example, multi-core processors 402 align with the chiplets or group of chiplets 108 depicted in FIG. 1, FIG. 2, and FIG. 3. In at least one example, the multi-core processors 402 are advanced computing units that can integrate one or more processor cores into a single chiplet or die. An individual processor core within multi-core processor 402 can operate independently to execute multiple threads or tasks simultaneously. Additionally, the operating system of the multi-core processors 402 can distribute workloads across multiple processing cores, and thus can operate at a lower frequency, reducing heat generation and power consumption.

In at least one example, multi-core processors 402 are interconnected via bridge dies 106 that may be surrounded or embedded in substrate 102. FIG. 4A illustrates one bridge die from one or more bridge dies 106, partially connecting various processor cores in multi-core processor 402-0 with the ones in multi-core processor 402-1, and another bridge die from one or more bridge dies 106, partially connecting various processor cores in multi-core processor 402-1 with the ones in multi-core processor 402-2. Similarly, bridge dies 106 can be used to couple various multi-core processors. In at least one example, every two processors (e.g., chiplets or group of chiplets) can share a bridge die. In at least one example, every four processors can share a bridge die. In other examples, any number of processors may share a bridge die. In at least one example, the bridge dies 106 are equipped with conductive routing traces that may be coupled to processing cores within multi-core processors 402. In at least one example, bridge dies 106 may include drivers and switches to route signals from one end to another end of multi-core processors 402. In at least one example, bridge dies 106 are programmable dies that can be programmed by hardware (e.g., fuses) or software, or a combination thereof.

To maintain redundancy in the wafer-scale systems, redundant chiplets may be used to ensure reliability and fault tolerance. Chiplets may also use extra wiring or interconnects to facilitate communication based on an indication (e.g., fault), in accordance with at least one example. In at least one example, extra wiring or interconnects may be used to signal a communication even in the absence of a fault. One such example is illustrated by FIG. 4A, where bridge dies 106 comprise one or more interconnects, e.g., set of principle interconnects 110, and set of redundant interconnects 112, on which signals can be transmitted/received based on the indication. In at least one example, the operating systems or the logic units can employ a first encoding scheme or a second encoding scheme based on the indication. The indication of a first logic level can result in employment of the first encoding scheme that transmits and/or receives signals over some of the redundant interconnects. An indication of a second logic level can result in employment of the second encoding scheme that transmits and/or receives signals over set of principle interconnects 110 and set of redundant interconnects 112.

In at least one example, the indication can be a binary indication that may be generated based on logic levels, either zero (0) or one (1). One such example is illustrated here, where an indication may manifest as a change in the logic levels. In at least one example, the first logic level can be 1 and the second logic level can be 0. In at least one example, the first logic level can be 0 and the second logic level can be 1. In at least one example, the first logic level may be different from the second logic level. In at least one example, the first logic level may be defined and implemented on multi-core processors 402 with a fault.

In at least one example, the indication may come from an operating system that may be stored and/or executed on multi-core processors 402 to manage processes and collaborate with other multi-core processors 402. The indication may come from one or more logic units associated with multi-core processors 402 or processor cores, such as fault detection circuits or status monitoring logic, in accordance with at least one example. The indication of the first logic level can be based on anomalies, e.g., signal errors or performance degradation. In at least one example, the indication of the first logic level may be generated based on overheating, such that multi-core processors 402 may run above an optimal temperature range which may lead to thermal damage. In at least one example, voltage drops or power fluctuations may generate an indication of the first logic level. In at least one example, latency issues in the communication paths may generate indication of the first logic level. In at least one example, hardware faults such as chiplets failure or connectivity issues may trigger indication of the first logic level. Furthermore, if a multi-core processors 402 fails, the operating system may switch to a redundancy mode, rerouting tasks and interconnects to redundant processors, in accordance with at least one example.

In at least one example, the indication of the first logic level (e.g., if a fault is detected) may employ the first encoding scheme. For example, if a processor core in multi-core processor 402 becomes faulty, the operating system may use set of redundant interconnects 112 associated with multi-core processor 402, bypassing the faulty processor core to reclaim a logical configuration by reconnecting to a redundant processor core.

In at least one example, the first encoding scheme is a binary encoding scheme, which uses fewer bits by representing data as binary numbers, wherein all signal lines in set of redundant interconnects 112 may be used to signal. For example, to transmit data, each bit can be encoded into electrical signals and sent over by signal lines of the set of redundant interconnects 112. In at least one example, the electrical signals may be associated with voltage levels, typically a high voltage representing one (active state) and a low voltage representing zero (inactive state). In at least one example, the electrical signals may be associated with voltage levels, wherein the high voltage represents an inactive state and the low voltage represents an active state. In at least one example, the first encoding scheme is a binary encoding scheme, which uses fewer bits by representing data as binary numbers. In at least one example, the first encoding scheme may have a high transition probability, which may lead to more consumption of transition energy (e.g., to change states) and thus to more consumption of dynamic power.

In at least one example, the default encoding scheme applied to the wafer-level assembly of multi-core processors 402 can be the second encoding scheme, and the redundancy mode is activated based on the indication of the first logic level. In at least one example, the indication of the second logic level is in the absence of the fault. In at least one example, the indication of the second logic level is to operate the wafer-level system in a high-performance mode (e.g., turbo mode), where resources can be fully utilized. For example, if the operating system detects no anomaly, the operating system may switch to a turbo mode, an operational state designed for power efficiency and noise tolerance. In at least one example, the indication of the second logic level may be operation specific.

In at least one example, the indication of the second logic level (e.g., if no fault is detected, switch to turbo mode etc.) may employ the second encoding scheme that applies signals over set of principle interconnects 110 and set of redundant interconnects 112. In at least one example, the operating system may start signaling over double the number of wires, for signaling the same number of bits, based on the indication of the second logic level. For example, if 1 Giga bits of data is signaled over two wires using the traditional encoding scheme, switching to the second encoding scheme, may signal 1 Gigabits of data over four wires, reducing power consumption of the wires by approximately 50%. In at least one example, the second encoding scheme is a one-hot encoding scheme that may signal using one-hot bit to reduce the transition probability and thus the associated transition energy. In at least one example, the second encoding scheme may have one bit that may be in an active state: all signal lines of set of principle interconnects 110 and set of redundant interconnects 112 may not be engaged. Thus, the second encoding scheme may use more channels or signal lines, but dynamic power consumption may significantly decrease.

In at least one example, the one-hot encoding scheme may represent discrete values or data as binary vectors, where one bit is set to be in an active state and all other bits are set to be in inactive state. In at least one example, the one-hot encoding scheme requires ‘n’ wires or signal lines, where each wire or signal line may represent one of the possible states. Therefore, one-hot encoding scheme simplifies state transition logic, which may directly influence the transition probabilities and toggling behavior, in accordance with at least one example. In one-hot wafer-scale systems, to transition from one state to another may typically involve toggling just one bit, which can lead to lower likelihood of errors and reduced dynamic power consumption. In contrast, the first encoding scheme or the traditional encoding schemes may use multiple bits to toggle simultaneously, which may not merely increase the risk of glitches but can also complicate the detection of state changes. Thus, one-hot encoding scheme enhances the reliability of state transitions and makes use of unused set of redundant interconnects even in the absence of a fault and/or on the indication of the second logic level.

In at least one example, multi-core processors 402 within the wafer-level assembly of multi-core processors may be interconnected in a 2D torus configuration, in which every processor 402 is connected to four adjacent processors 402. The 2D torus configuration can help minimize latency and can provide fault tolerance. In at least one example, the 2D torus configuration comprises of set of principle interconnects 110 and set of redundant interconnects 112, such that the 2D torus configuration may also support the first encoding scheme and the second encoding scheme based on an indication. In at least one example, multi-core processors 402 can be equipped with built-in encoding capabilities that can convert binary data into signals which can be applied over signal lines of set of principle interconnects 110 or set of redundant interconnects 112, to support the first and second encoding schemes. In wafer-level systems, processor cores within a multi-core processor 402 can function as encoders, in accordance with at least one example.

In at least one example, encoders can be part of the communication interface of multi-core processors 402, or processor cores that can facilitate the transmission of signals between multi-core processors 402, or the processor cores via the set of principle interconnects 110 and the set of redundant interconnects 112. In at least one example, encoders can be implemented as software algorithms that can process data by applying specific encoding techniques, e.g., the first encoding scheme and the second encoding scheme. In at least one example, the algorithms can apply control mechanics over switches to toggle between states (e.g., an active state and an inactive state), to accurately encode the data for transmission. In at least one example, the algorithms may dynamically adjust its parameters based on the indication of the first logic level or the second logic level and can precisely control over the timing and frequency of state changes. In at least one example, the algorithms can toggle between binary states to transmit multiple bits simultaneously.

For example, based on the indication of the first logic level (e.g., in an event of a fault), the algorithms associated with the encoder can apply the first encoding scheme over some of sets of redundant interconnects 112. In at least one example, the first encoding scheme is a binary encoding scheme, which uses fewer bits by representing data as binary numbers. In at least one example, the first encoding scheme is wire efficient, e.g., it signals over some of the sets of redundant interconnects 112 and not on the set of principle interconnects 110. The algorithms associated with the encoder can apply the second encoding scheme over the sets of principle interconnects 110 and sets of redundant interconnects 112, based on the indication of the second logic level (e.g., in the absence of the fault, to switch to turbo mode or the like). In at least one example, the second encoding scheme is a one-hot encoding scheme that can signal using one hot-bit over the set of principle interconnects 110 and set of redundant interconnects 112. In at least one example, the second encoding scheme is wire inefficient, e.g., the second encoding scheme uses double the number of interconnects to signal the same number of bits.

FIG. 4B is a schematic of a multi-core processor 402 with a plurality of bridge dies, in accordance with at least one embodiment. In at least one example, multi-core processors 402 is an advanced computing unit that can integrate multiple processor cores 404-0, 404-1, . . . , 404-m into a single chiplet or base die. One such example is illustrated in FIG. 4B, where multi-core processor 402 includes plurality of processor cores 404-0, 404-1, . . . , 404-m on base die 302. Processor cores such as 404-0, 404-1, . . . , 404-m can be collectively referred to as processor cores 404 or cores 404 and can be individually referred to as processor core 404 or core 404. In at least one example, processor cores 404 within multi-core processor 402 can operate independently to execute multiple threads or tasks simultaneously. Additionally, the operating system of multi-core processors 402 can distribute workloads across multiple processor cores 404, and thus can operate at a lower frequency, reducing heat generation and power consumption. In at least one example, processor cores 404 may act as individual processors mounted on base die 302, collectively forming a single chip. In at least one example, multiple single chips can be mounted onto substrate 102, creating a multi-chip assembly.

In at least one example, bridge dies 106 can be incorporated into base die 302 to provide connections between one or more processors 402 or processor cores 404. One such example is illustrated in FIG. 4B, where base die 302 may serve as the foundation for processor cores 404 and may be equipped with bridge dies 106 that can facilitate connections between processor cores 404 mounted on the base die 302. In at least one example, bridge die 106 may be present partially under processor core 404-0 and processor core 404-1. In at least one example, every two processor cores share a bridge die. In at least one example, every four processor cores share a bridge die. In other examples, any number (say n) of processor cores may share a bridge die. In at least one example, bridge dies 106 serves as an intermediary that helps in reducing the distance electrical signals need to travel, improving performance and reducing latency. In at least one example, bridge dies 106 provide a low-resistance path for signals between processor cores 404 that maintains signal integrity and reduces losses. In at least one example, bridge dies 106 can assist in dissipating heat across multiple cores 404, serving as a thermal interface. This helps manage heat more efficiently in wafer-level assembly of multi-core processor architectures.

FIG. 4C is a schematic of a multi-core processor with integrated interconnect pathways, in accordance with at least another example. In at least one example, multi-core processors 402 may serve as an advanced computing unit that can integrate multiple processor cores 404 into a single chiplet or base die. One such example is illustrated in FIG. 4C, where processor cores 404 are mounted on a base die 302 that provides integrated interconnect pathways, such as metal traces or vias, which can route signals between processor cores 404. In at least one example, metal traces are conductive lines embedded within the base die 302, that can transmit electrical signals rapidly between processor cores 404. In at least one example, vias can provide vertical connections between substrate 102, base die 302, or processor cores 404, to facilitate the distribution of power and ground connections throughout base die 302. Vias enable a more compact design, as it allows the efficient use of the vertical space of the substrate to manage efficiently electrical connections without cluttering the surface layer of the base die.

In at least one example, metal traces can provide conductive pathways that can be referred to as set of principle interconnects 110 and set of redundant interconnects 112, on which signals can be applied based on an indication. In at least one example, the operating systems or the logic units can employ the first encoding scheme or the second encoding scheme based on the indication. The indication of first logic level can result in employment of the first encoding scheme that transmits and/or receives signal over some of the redundant interconnects (e.g., the redundant interconnects associated with a faulty processor core). The indication of the second logic level can result in employment of the second encoding scheme that transmits and/or receives signal over set of principle interconnects 110 and set of redundant interconnects 112. For example, if a processor core 404 in a multi-core processor 402 experiences a fault, the operating system can utilize a set of redundant wires to circumvent the core that is malfunctioning. The operating system can maintain its logical configuration by reconnecting to a redundant core. By dynamically rerouting tasks to the redundant core, the operating system provides continued performance and reliability.

The methods and apparatuses of some examples can be implemented for homogeneous or heterogeneous chiplets to integrate them on systems such as wafer-level systems. In at least one example, redundancy is achieved through a combination of fully-connected, fat-tree, mesh, or torus topologies.

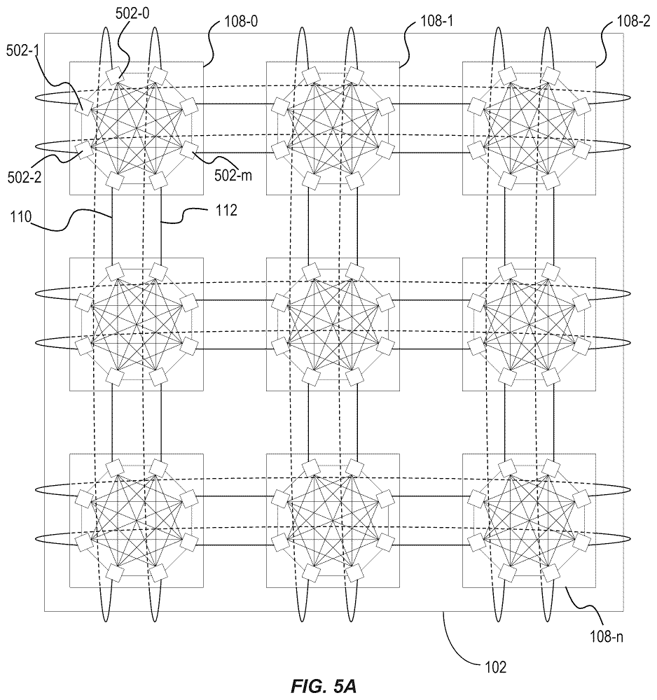

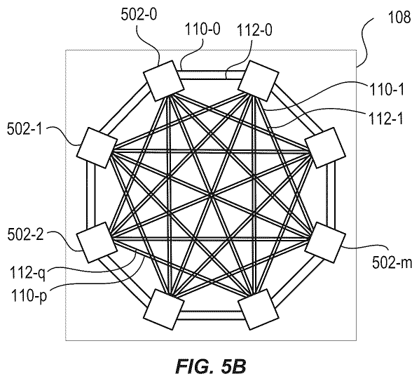

FIG. 5A is a schematic of a wafer-level assembly of groups of chiplets connected in a fully-connected torus configuration, in accordance with at least one example.

Here, a “fully-connected topology” generally refers to a type of network configuration where every node (device) in the network is directly connected to every other node. This means that for a network with n nodes, there are a total of n(n−1)/2 direct connections or links. Each device can communicate directly with every other device in the network without needing to go through a central hub or switch. If one link fails, the network can still function because there are multiple other paths for communication among devices. Direct connections can lead to lower latency in communication since data can be sent directly to the destination.

Here, a “torus topology” generally refers to a network design for high-performance computing systems and parallel processing environments. A torus topology is an extension of a mesh topology, wherein nodes are connected in a grid-like pattern, with an additional wrap-around connection that forms a closed loop, resembling a torus (doughnut) shape. In at least one example, the torus topology may provide multiple redundant paths between the components, enhancing fault tolerance and reducing network congestion. Having a multidimensional design, a torus topology can be constructed by arranging components or groups of components in a multi-dimensional grid, in which each dimension is cyclically connected to all others. In a torus topology, components or groups of components on edges of a grid are connected to the components or groups of components on the opposite edge. This may create a continuous loop in each dimension, reducing the diameter of the network. Torus topologies can be designed in multiple dimensions (e.g., one dimensional (1D), two-dimensional (2D), three-dimensional (3D), or even higher).

In a 2D torus topology, each node has four direct neighbors, while in a 3D torus topology, each node has six direct neighbors (two in each dimension). In an n dimensional (nD) torus topology, each node has 2×n direct neighbors. The wrap-around connections may decrease the network diameter, allowing data to travel across the network in fewer hops compared to a regular mesh. Torus topology may reduce latency and improve communication efficiency. Multiple paths between any two nodes may provide redundancy, enhancing fault tolerance. If one path fails, data may be rerouted through alternative paths, maintaining network reliability. Torus topologies may be easily scaled by adding more nodes or dimensions. Higher-dimensional tori (e.g., 3D, 4D, etc.) may offer even greater scalability and performance, making them suitable for large-scale systems. Regular structure of a torus topology may ensure uniform bandwidth across the network, preventing bottlenecks and allowing consistent data flow. Adaptive routing algorithms may distribute traffic evenly across the network, balancing the load and preventing congestion hotspots.

Wafer-level assembly includes wafer scale integration (WSI) of chiplets. In at least one example, chiplets 502-0, 502-1, . . . , 502-m are connected in groups of chiplets 108-0, 108-1, 108-2, . . . , 108-n depicted in FIG. 1 (herein, referred to as groups of chiplets 108). Chiplets such as 502-0, 502-1, . . . , 502-m can be collectively referred to as chiplets 502, and can be individually referred to as chiplet 502. In at least one example, chiplets 502 may align with individual chiplets 304 on the base die 302 depicted in FIG. 3. In at least one example, groups of chiplets 108 may be connected in a mesh or torus topology.

In at least one example, groups of chiplets 108 are mounted on substrate 102. In at least one example, substrate 102 includes a redistribution layer (RDL), with embedded interconnects, to interconnect groups of chiplets 108. In at least one example, chiplets 108 are interconnected via bridge dies 106 that may be surrounded or embedded in substrate 102. In at least one example, substrate 102 includes active or passive devices. In at least one example, substrate 102 is an interposer providing electrical connections between different chiplets or different groups of chiplets 108. In at least one example, the interposer acts like a miniature printed circuit board (PCB), facilitating high-bandwidth connectivity and short-distance point-to-point paths between different chiplets or groups of chiplets 108. In at least one example, substrate 102 is an interposer, handles other functions such as external input/output (I/O) interfaces, power distribution, and system management, etc.

In at least one example, intergroup connections (e.g., global connections) among groups of chiplets 108 interconnect groups of chiplets 108 in a mesh topology. In at least one example, the intergroup connections comprise of one or more interconnects, e.g., set of principle interconnects 110 and set of redundant interconnects 112, on which signals can be applied based on an indication. In at least one example, the operating systems or the logic units can employ a first encoding scheme or a second encoding scheme based on the indication. The indication of a first logic level can result in an employment of the first encoding scheme that applies signal over some but not all sets of redundant interconnects 112. The indication of a second logic level can result in an employment of the second encoding scheme that applies signal over set of principle interconnects 110 and set of redundant interconnects 112.

In at least one example, groups of chiplets 108 are interconnected in a 2D torus configuration, in which every group of groups of chiplets 108 is connected to four adjacent groups of groups of chiplets 108. The 2D torus configuration can help minimize latency and can provide fault tolerance. In at least one example, the 2D torus configuration may comprise of set of principle interconnects 110 and set or redundant interconnects 112, such that the 2D torus configuration may also support the first encoding scheme and the second encoding scheme based on an indication. In at least one example, the indication may manifest as a change in the logic levels, e.g., either zero (0) or one (1). In at least one example, the first logic level can be 1 and the second logic level can be 0. In at least one example, the first logic level can be 0 and the second logic level can be 1. In at least one example, the first logic level may be different from the second logic level. In at least one example, the first logic level may be defined and implemented on chiplets 502 that are faulty.

In at least one example, the indication of the first logic level (e.g., if a fault is detected), may employ the first encoding scheme. In at least one example, the first encoding scheme is a binary encoding scheme, which can use fewer bits by representing data as binary numbers. In at least one example, the first encoding scheme is a traditional encoding scheme that may use a parallel interface to apply signals over some of the redundant interconnects associated with group of chiplets 108 having a fault. For example, if chiplet 502 in a group of chiplets 108 become faulty, the operating system may use set of redundant wires associated with the group of chiplets 108, bypassing the one or more faulty chiplets and reclaiming the logical configuration by reconnecting to one or more redundant chiplets. In at least one example, the first encoding scheme may have high a transition probability, as signals are applied only to an associated set of redundant interconnects and not on an associated set of principle interconnects. In at least one example, the indication of the second logic level (e.g., if no is fault detected, switch to a turbo mode etc.) may employ the second encoding scheme that applies signals over set of principle interconnects 110 and set of redundant interconnects 112. In at least one example, operating system can start signaling over double the number of interconnects (e.g., set of principle interconnects and set of redundant interconnects), for signaling the same number of bits, based on an indication of the second logic level. In at least one example, the second encoding scheme is a one-hot encoding scheme that may signal using one-hot bit to reduce the transition probability.

In at least one example, groups of chiplets 108 may be homogenous or heterogenous. A homogenous group may contain chiplets made with the same process technology, for example, complementary metal-oxide-semiconductor (CMOS). A heterogenous group may contain chiplets made with different technologies, for example, some chiplets may be fabricated with transistor-transistor logic (TTL) technology, others with the CMOS technology, and some chiplets may be manufactured from different technology CMOS nodes. A group of chiplets of groups of chiplets 108 may include chiplets of the same functionality or may include chiplets of different functionalities.

In at least one example, processors or processor cores can be chiplets 502 within a group of chiplets 108. In at least one example, chiplets 502 in a group of chiplets 108 may function as encoders to support a first encoding scheme and a second encoding scheme. In at least one example, encoders can be part of the communication interface of processors or processor cores that can facilitate the transmission of signals between the processors or the processor cores via set of principle interconnects 110 and set of redundant interconnects 112. In at least one example, chiplets 502 in a group of chiplets 108 may be graphical processing units (GPUs). In at least one example, chiplets 502 in a group of chiplets of groups of chiplets 108 can be functionally different from each other. For instance, the chiplet 502-0 may be a microprocessor, chiplet 502-1 may be a GPU, chiplet 502-2 may be a local area network (LAN) port, and chiplet 502-3 may be a double data rate (DDR) based random access memory (RAM), etc. In at least one example, a chiplet of chiplets 502 is an input or output device, sensor or port (e.g., a video graphics array (VGA) port, a universal serial bus (USB) port, a PS/2 port, a Wi-Fi port, an analog-to-digital converter (ADC), a digital-to-analog converter (DAC), a bridge input port, a thermocouple port, a thermistor port, an H-bridge driver, a pressure sensor, an accelerometer, a gyroscope, or a microphone, etc.).

FIG. 5B is a schematic of a fully-connected configuration of chiplets with one or more interconnects, in accordance with at least one example. In at least one example, chiplets 502-0, 502-1, . . . , 502-m are connected in a group of chiplets 108. In at least one example, some of chiplets 502 in group of chiplets 108 are redundant, such that redundant chiplets may take over the functionality of the chiplets 502 in the event of a failure or malfunction. By having redundant chiplets, the wafer-level assembly of chiplets can continue to function smoothly. In at least one example, the intragroup connections (e.g., local connections) among the chiplets 502 form the fully-connected configuration. In at least one example, the intragroup connections, among the chiplets 502 within a group of chiplets 108, comprises of interconnects, e.g., set of principle interconnects 110-0, 110-1, 110-2, . . . , 110-p and set of redundant interconnects 112-0, 112-1, 112-2, . . . , 112-q. Set of principle interconnects 110-0, 110-1, . . . , 110-p can be referred to as set of principle interconnects 110 and set of redundant interconnects 112-0, 112-1, . . . , 112-q can be referred to as set of redundant interconnects 112.

In at least one example, operating systems or the logic units of chiplets 502 or group of chiplet 108 can employ a first encoding scheme or a second encoding scheme based on an indication. The indication of a first logic level can result in an employment of the first encoding scheme that transmits and/or receives a signal over some of the redundant interconnects to bypass the faulty chiplet. In at least one example, the first encoding scheme is a traditional encoding scheme that may have a high transition probability, which may lead to a greater consumption of the transition energy (e.g., to change states), consuming greater dynamic power. The indication of a second logic level can result in an employment of the second encoding scheme that transmits and/or receives signal over set of principle interconnects 110 and set of redundant interconnects 112. In at least one example, the second encoding scheme is one-hot encoding scheme that may signal using one-hot bit to reduce the transition probability. In at least one example, the second encoding scheme may have one bit that may be in an active state, all signal lines of set of principle interconnects 110 and set of redundant interconnects 112 may not be engaged. Thus, the second encoding scheme may use more channels or signal lines but can still significantly reduce consumption of dynamic power.

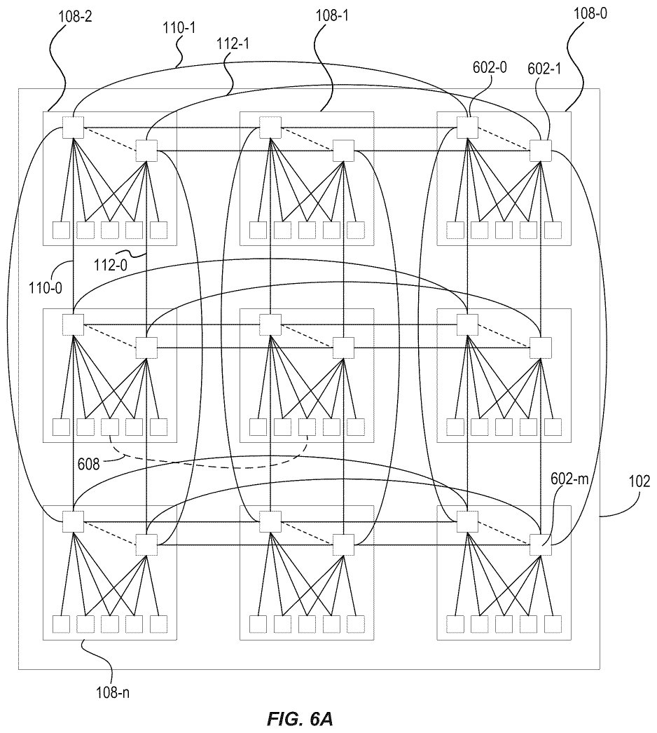

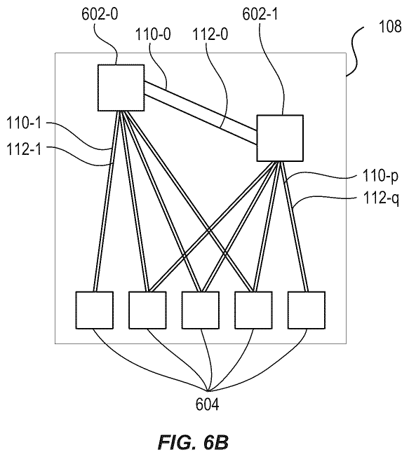

FIG. 6A is a schematic of a wafer-level assembly of groups of chiplets connected in a fat-tree torus configuration, in accordance with at least one example.

Here, “fat-tree network topology” may generally refer to a configuration of nodes with multiple layers, including core (or root), aggregation and edge (or leaf) layers. An individual layer may be connected to the layers above and below it. In a two-layer fat-tree network topology of chiplets (or nodes), a core layer in the hierarchy may comprise of one or more root-chiplets (e.g., root node), whereas an edge layer may comprise one or more leaf-chiplets (e.g., leaf nodes). The bandwidth of the interconnects may increase towards the core layer. In at least one example, root-chiplets or core switches may have higher capacity connections compared to leaf-chiplets or edge switches. Fat-tree network topology may balance the network load and avoid bottlenecks. The fat-tree connectivity topology may provide redundancy by providing multiple paths between any two nodes in a network. In case of failure of a link or a chiplet, traffic may be rerouted through alternative paths by software, thereby enhancing fault tolerance and reliability. More switches and links may be added to a fat-tree network topology of chiplets to accommodate more chiplets, thereby allowing scalability of the network without significant changes to the overall network structure. Groups of chiplets may be connected in a fat-tree network topology inside the group. Intergroup connectivity may be a mesh or a torus. A fat-tree network topology may be used in data centers and large-scale distribution systems. A fat-tree topology may improve network performance and scalability by providing redundancy and higher bandwidth.

The example herein is another architecture of a WSI of chiplets. In at least one example, the wafer-level assembly includes chiplets (e.g., root-chiplets and leaf-chiplets) connected in groups of chiplets 108. In at least one example, groups of chiplets 108 are mounted on substrate 102. In at least one example, substrate 102 includes a redistribution layer (RDL), with embedded interconnects, to interconnect groups of chiplets 108. In at least one example, groups of chiplets 108 are interconnected via bridge dies 106 that may be surrounded or embedded in substrate 102. In at least one example, substrate 102 includes active or passive devices. In at least one example, substrate 102 is an interposer providing electrical connections between different chiplets or different groups of chiplets 108. In at least one example, the interposer acts like a miniature printed circuit board (PCB), facilitating high-bandwidth connectivity and short-distance point-to-point paths between different chiplets or groups of chiplets 108. In at least one example, substrate 102 as an interposer handles other functions such as external input/output (I/O) interfaces, power distribution, and system management, etc.

In at least one example, intergroup connections (global connections) among groups of chiplets 108 interconnect groups of chiplets 108 in a mesh topology. Intergroup connections may comprise one or more interconnects, e.g., set of principle interconnects 110 and set of redundant interconnects 112, on which signals can be transmitted and/or received based on an indication. In at least one example, an operating system or logic units associated with chiplets or group of chiplets 108 can employ a first encoding scheme or a second encoding scheme based on an indication. The indication of a first logic level can result in an employment of the first encoding scheme that applies signal over some of the redundant interconnects. The indication of a second logic level can result in an employment of the second encoding scheme that applies signal over set of principle interconnects 110 and set of redundant interconnects 112.

In at least one example, groups of chiplets 108 are interconnected in a 2D torus configuration, in which every group of groups of chiplets 108 is connected to four adjacent groups of groups of chiplets 108. The 2D torus configuration can help minimize latency and can provide fault tolerance. In at least one example, the 2D torus configuration may comprise set of principle interconnects 110 and set or redundant interconnects 112, such that the 2D torus configuration may also support the first encoding scheme and the second encoding scheme based on an indication. In at least one example, some of the leaf-chiplets in one group of chiplets 108 may be connected through interconnects 608 to some leaf-chiplets in another group of chiplets of groups of chiplets 108 to provide additional redundant connectivity. This interconnection topology may reduce the distance that data needs to travel from one chiplet to another, which may improve communication efficiency and may reduce latency. The interconnected structure provides redundancy, ensuring that if chiplet fails, data can be rerouted through one or more other chiplets.

In at least one example, an indication may be from change in the logic levels, e.g., either zero (0) or one (1). In at least one example, the first logic level can be 1 and the second logic level can be 0. In at least one example, the first logic level can be 0 and the second logic level can be 1. In at least one example, the first logic level may be different from the second logic level. In at least one example, the first logic level may be defined and implemented on chiplets that may be faulty. In at least one example, the indication of the first logic level (e.g., if a fault is detected), may employ the first encoding scheme. In at least one example, the first encoding scheme is a traditional encoding scheme that may use a parallel interface, to apply signal over some of the redundant interconnects associated with group of chiplets 108 having a fault. In at least one example, the indication of the second logic level (e.g., if no fault is detected, switch to a turbo mode, etc.) may employ the second encoding scheme that applies signals over set of principle interconnects 110 and set of redundant interconnects 112. In at least one example, the second encoding scheme is a one-hot encoding scheme that may signal using one-hot bit to reduce the transition probability.

In at least one example, groups of chiplets 108 may be homogenous or heterogenous. A homogenous group may contain chiplets made with the same process technology, for example, complementary metal-oxide-semiconductor (CMOS). A heterogenous group may contain chiplets made with different technologies, for example, some chiplets may be fabricated with transistor-transistor logic (TTL) technology, others with the CMOS technology, and some chiplets may be manufactured from different technology CMOS nodes. A group of chiplets of groups of chiplets 108 may include chiplets of the same functionality or may include chiplets of different functionalities.

In at least one example, processors or processor cores can be chiplets (e.g., root-chiplets and/or leaf-chiplet) within a group of chiplets 108. In at least one example, the chiplets in a group of chiplets 108 may function as encoders to support a first encoding scheme and a second encoding scheme. In at least one example, the encoders can be part of a communication interface of processors or processor cores that can facilitate the transmission of signals between the processors or the processor cores via set of principle interconnects 110 and set of redundant interconnects 112. At least for one example, chiplets in a group of chiplets 108 may be graphical processing units (GPUs). In at least one example, chiplets in a group of chiplets 108 may be functionally different from each other. For instance, a chiplet may be a microprocessor, a GPU, a local area network (LAN) port, a double data rate (DDR) based random access memory (RAM), etc. In at least one example, a chiplet of chiplets is an input or output device, sensor or port (e.g., a video graphics array (VGA) port, a universal serial bus (USB) port, a PS/2 port, a Wi-Fi port, an analog-to-digital converter (ADC), a digital-to-analog converter (DAC), a bridge input port, a thermocouple port, a thermistor port, an H-bridge driver, a pressure sensor, an accelerometer, a gyroscope, or a microphone, etc.).

FIG. 6B is a schematic of fat-tree configuration with one or more interconnects, in accordance with at least one example. In at least one example, root-chiplets 602-0, 602-1, . . . , 602-m and leaf-chiplets 604 are connected in groups of chiplets 108. Root-chiplets such as 602-0, 602-1, . . . , 602-m may be collectively referred to as root-chiplet 602, and may be individually referred to as root-chiplet 602. In at least one example, the intragroup connections (local connections), among the chiplets within group of chiplets 108, comprises interconnects, e.g., set of principle interconnects 110-0, 110-1, . . . , 110-p and set of redundant interconnects 112-0, 112-1, . . . , 112-q.

In at least one example, chiplets in group of chiplets 108 are connected in a fat-tree topology (hierarchically connected graph) through set of principle interconnects 110 and set of redundant interconnects 112. In at least one example, fat-tree topology starts with a root-chiplet 602-0, which branches out to leaf-chiplets 604. In at least one example, fat-tree topology starts with more than one root-chiplet 602-0, 602-1, etc. In at least one example, root-chiplets 602 are not internally connected inside a group of chiplets 108. In at least one example, root-chiplets 602 are internally connected inside group of chiplets 108 through set of principle interconnects 110 and set of redundant interconnects 112. In at least one example, leaf-chiplets 604 may further branch out to their own leaf-chiplets, which may create a hierarchical structure.

Each level of fat-tree topology may represent a different layer of chiplets, with root-chiplets 602 at the top and leaf-chiplets 604 at the bottom. Here, top and bottom are used to logically describe FIG. 6B and are not necessarily chiplets above and below another although that is also possible and within the scope of the examples. In at least one example, root-chiplets 602 may act as central hubs for communication, managing data flow to and from leaf-chiplets 604, which may centralize control by simplifying management of data traffic and may reduce latency for critical communications. In at least one example, groups of chiplets 108 may be connected in a mesh or torus topology through root-chiplets 602.

In at least one example, operating systems or the logic units of the chiplets or group of chiplets 108 can employ first encoding scheme or second encoding scheme on root-chiplets 602 and leaf-chiplets 604, based on an indication. In at least one example, indication of a first logic level can result in an employment of the first encoding scheme that transmits and/or receives signal over some of the redundant interconnects to bypass faulty chiplets within the fat-tree topology. In at least one example, the first encoding scheme is a traditional encoding scheme that may have a high transition probability, which may lead to more consumption of transition energy (e.g., to change states) and consequently to more consumption of dynamic power. In at least one example, indication of a second logic level can result in an employment of the second encoding scheme that transmits and/or receives signals over set of principle interconnects 110 and set of redundant interconnects 112. In at least one example, the second encoding scheme is one-hot encoding scheme that may signal using one-hot bit to reduce the transition probability. In at least one example, the second encoding scheme may have one bit that may be in an active state, all principle interconnects 110 and redundant interconnects 112 may not be engaged. Thus, the second encoding scheme may use more channels or signal lines, still dynamic power consumption may decrease significantly.

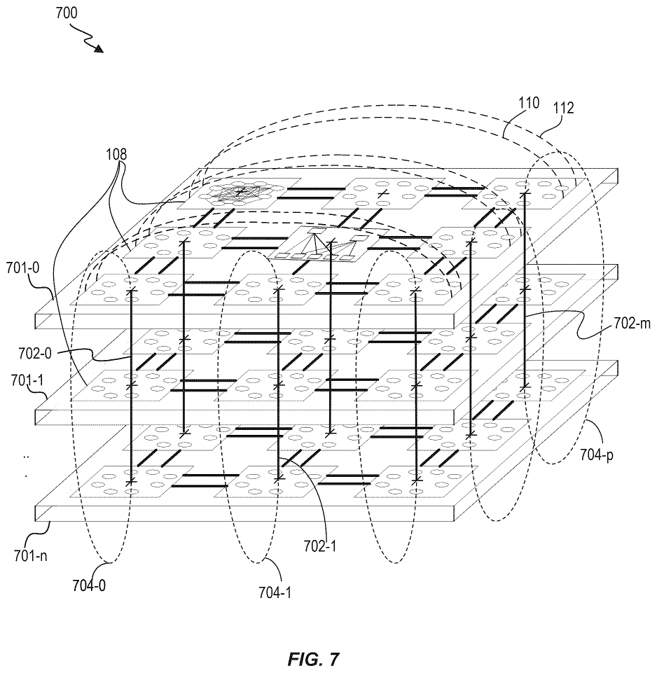

FIG. 7 is a schematic of a 3D architecture 700 of wafer-level assembly of chiplets connected in a 3D torus configuration by through-silicon via (TSV), in accordance with at least one example. In at least one example, 3D architecture 700 includes stacking of wafer-level assemblies 701-0, 701-1, . . . , 701-n that are connected through vertical interconnects such as through-silicon vias (TSVs) 702-0, 702-1, . . . , 702-m, copper-to-copper bonding, copper-to-copper hybrid bonding, etc. Wafer-level assemblies 701-0, 701-1, . . . , 701-n may be generally referred to as wafer-level assembly 701. In at least one example, wafer-level assembly 701 may include wafer-level assembly of groups of chiplets 100, wafer-level assembly of multi-core processors of FIG. 4A, wafer-level assembly of groups of chiplets of FIG. 5A, or wafer-level assembly of groups of chiplets of FIG. 6A.

In at least one example, TSVs 702-0, 702-1, . . . , 702-m are vertical electrical connections that pass through a silicon wafer or may be across the layers. TSVs such as 702-0, 702-1, . . . , 702-m may be collectively referred to as TSVs 702, and may be individually referred to as TSV 702. TSV 702 may be utilized to create high-performance interconnect in 3D ICs and packages. In at least one example, wafer-level assembly 701 is stacked vertically with one or more wafer-level assemblies and interconnected by TSV 702. Stacking of wafer-level assemblies 701 may allow for high-density integration and efficient communication between the wafer-level assemblies. TSVs 702 may provide vertical electrical connections through silicon wafers enabling wafer-level assemblies 701 to function as a cohesive unit. TSVs 702 may enable compact and efficient designs. In at least one example, wafer-level assemblies 701 are connected in a 3D mesh topology. In at least one example, groups of chiplets 108 in a top layer wafer-level assembly are connected to groups of chiplets 108 in a bottom layer wafer-level assembly through interconnects 704-0, 704-1, . . . , 704-p to interconnect wafer-level assemblies 701 in a 3D torus configuration. Interconnects 704-0, 704-1, . . . , 704-p includes set of principle interconnects 110 and set of redundant interconnects 112 to support one or more encoding schemes (e.g., a first encoding scheme and a second encoding scheme). In at least one example, groups of chiplets 108 are interconnected in a 3D torus configuration, in which every group is connected to adjacent groups (e.g., six adjacent groups).

In the context of wafer-level assemblies 701 on a silicon wafer substrate, a switchless fully-connected or fat-tree topology can be used, in accordance with at least one example. The architecture of some examples leverages wafer-scale systems to eliminate the need for high-radix switches. The architecture of some examples may use distributed high-bandwidth networks-on-chip (NoC) in or on the silicon wafer in wafer-level assemblies 701. The architecture of some examples enhances local throughput and maintains global throughput, making it a promising solution for future large-scale supercomputers. Local throughput refers to data processing speed within a single node or a specific region of a supercomputer. For example, local throughput may be improved by integrating a high-bandwidth memory within or close to a processor, thereby reducing latency and increasing data transfer rates, or by leveraging advanced caching mechanisms and memory hierarchies. Global throughput refers to the performance and efficiency of data transfer and processing across a complete supercomputer, including communication between various nodes. Global throughput may be improved, for example, by using high-speed network technologies and interconnects, implementing scalable network architectures, such as fat-tree, fully-connected, or hypercube topologies, or optimizing distributed memory access patterns by using advanced algorithms for data distribution.

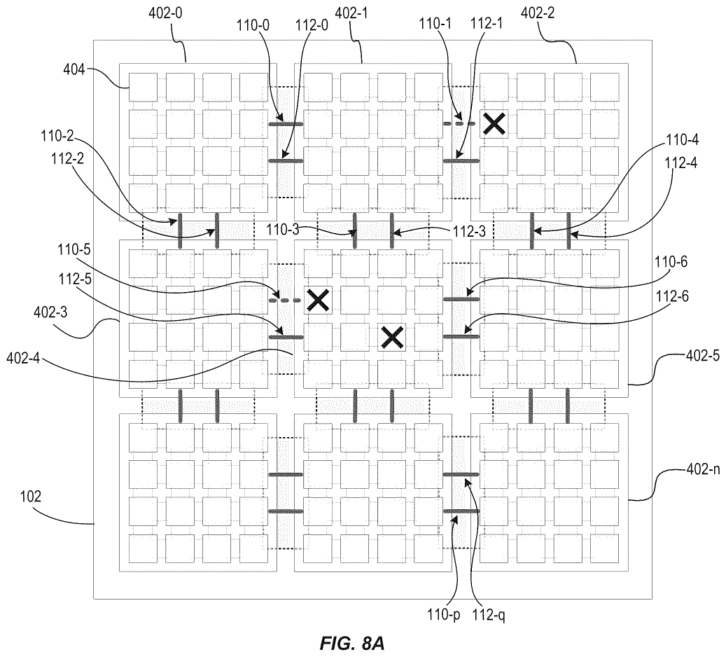

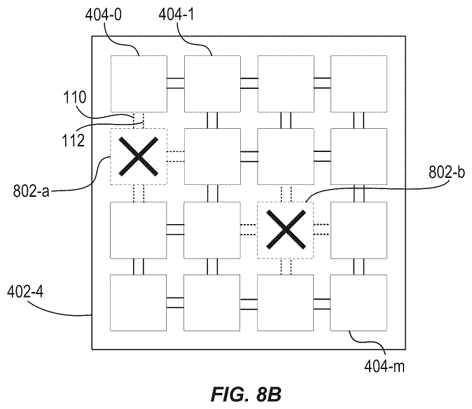

FIG. 8A is a schematic of a wafer-level assembly of multi-core processors with redundancy and employment of one or more encoding schemes, in accordance with at least one example. Redundancy in multi-core processors 402 can provide backup options in case of failures. For instance, if one processor core 404 within a multi-core processor 402 fails, due to manufacturing defects, operational aging, or environmental stress, the wafer-scale system can activate a redundant processing core to keep performing its functions efficiently (e.g., the wafer-scale system can switch to a redundancy mode for the associated faulty cores). In at least one example, redundancy can also extend to one or more interconnects, such that if a set of principle interconnects 110 fails, a set of redundant interconnects 112 can be utilized to communicate between the processor cores 404. The processor core or interconnect failure can occur at a functional level (e.g., impacting the performance of the wafer-scale system) or at a bonding level (e.g., affecting the connectivity between the cores).

In at least one example, if processor cores 404 within multi-core processors 402, and a set of one or more interconnects associated with multi-core processors 402, are functioning properly, the wafer-scale system can transmit signals between multi-core processors 402 using a second encoding scheme (e.g., the wafer-scale system can switch to a turbo mode). One such example is illustrated in FIG. 8A, that employs both the first encoding scheme and the second encoding scheme, based on an indication.

One or more processor cores 404 within processors 402 may become faulty, including one processor core of processor 402-2 and two processor cores of processor 402-4. The faulty processor core of processor 402-2 and one of the faulty processor cores of processor 402-4 is interconnected via set of principle interconnects 110-1 and 110-5. In at least one example, operating system of one or more logic units associated with the processors may detect the fault and signal an indication of a first logic level to processors 402-2 and 402-4. Based on the indication of the first logic level, processors 402-2 and 402-4 can transmit and/or receive signals over set of redundant interconnects 112-1 and 112-5, using the first encoding scheme.

In at least one example, the first encoding scheme is a traditional encoding scheme that may use a parallel interface, wherein all signal lines in set of redundant interconnects 112 may be used to signal a communication. In at least one example, the first encoding scheme is a binary encoding scheme, which uses fewer bits by representing data as binary numbers, wherein all signal lines in set of redundant interconnects 112 may be used to signal a communication. In at least one example, the first encoding scheme may have a high transition probability, which may consume more transition energy (e.g., to change states), leading to consuming dynamic power.

In the present embodiment, processor cores 404 within processors 402-0, 402-1, 402-3, 402-5, . . . , 402-n and all sets of primary interconnects (except primary interconnects 110-1 and 110-5) are functioning properly, thus the operating system or one or more logic units signals an indication of a second logic level to the associated processors and the associated set of interconnects. Based on the second logic level, processors 402-0, 402-1, 402-3, 402-5, . . . , 402-n can transmit and/or receive signals over set of principle interconnects 110-0, 110-2, 110-3, 110-4, 110-5, 110-6, . . . , 110-p and set of redundant interconnects 112-0, 112-2, 112-3, 112-4, 112-6, . . . , 112-q using the second encoding scheme.

In at least one example, the operating system or one or more logic units may start signaling over double the number of wires (e.g., set of principle interconnects and set of redundant interconnects), for signaling the same number of bits, based on an indication of a second logic level. For example, if 1 Gigabit of data is signaled over two wires using a first encoding scheme, switching to a second encoding scheme, may signal 1 Gigabit of data over four wires and thus can reduce the power consumption by 50%. In at least one example, the second encoding scheme is a one-hot encoding scheme that may signal using one-hot bit to reduce the transition probability and thus the transition energy. In at least one example, the second encoding scheme may have one bit that may be in an active state, all signal lines within the set of principle interconnects 110-0, 110-2, 110-3, 110-4, 110-6, . . . , 110-p and the set of redundant interconnects 112-0, 112-2, 112-3, 112-4, 112-6, . . . , 112-q may not be engaged. Thus, the second encoding scheme may use more channels or signal lines, yet it may lower the dynamic power consumption.

In at least one example, the default encoding scheme applied to the wafer-level assembly of multi-core processors can be the second encoding scheme, the redundancy mode is activated based on an indication of the first logic level. In at least one example, the indication of a second logic level is to operate the wafer-scale system in a high-performance mode (e.g., a turbo mode), where resources can be fully utilized. For example, if the operating system detects no anomaly, the operating system may switch to the turbo mode, an operational state designed for power efficiency and noise tolerance. In at least one example, the indication of a second logic level can be operation specific.

In at least one example, the given description of redundancy in the wafer-level assembly of multi-core processors can be applied to any wafer-level assemblies described herein. The wafer-level assemblies 701 may include the wafer-level assembly of FIG. 4A, the wafer-level assembly of FIG. 5A or the wafer-level assembly of FIG. 6A.

FIG. 8B is a schematic of a multi-core processor with a redundancy which mitigates failures, and an employment of one or more encoding schemes, in accordance with at least one example. For instance, if one or more processor cores 404 or one or more interconnects in a wafer-level assembly of the multi-core processor 402 fails for any reason, one or more redundant processor cores 404 or one or more redundant interconnects may be activated to replace the failed one or more processor cores or one or more interconnects. The failure of processor cores 404 or interconnects may be at a functional level or at a physical level (e.g., bonding issues). The failure of processor cores 404 may be at the time of manufacturing or during operations due to aging or environmental stresses. One such example is illustrated in FIG. 8B, where processor 402-4 (e.g., depicted in FIG. 8A) may have two faulty processor cores 802-a and 802-b. In at least one example, due to the faulty processor cores 802-a and 802-b, the dotted set of principle interconnects and set of redundant interconnects may not be used. Traffic can be rerouted through adjacent communication pathways (e.g., set of principle interconnects 110 and set of redundant interconnects 112), shown by solid signal lines. In at least one example, processor cores 404 may apply signals over set of principle interconnects 110 and set of redundant interconnects 112 using a second encoding scheme. In at least one example, the second encoding scheme is a one-hot encoding scheme.

In at least one example, the given description of redundancy in multi-core processor can also be applied to any chiplets within a group of chiplets 108, described herein. For example, chiplets within a group of chiplets connected in a fully-connected configuration of FIG. 5B or chiplets within a group of chiplets connected in fat-tree configuration of FIG. 6B.

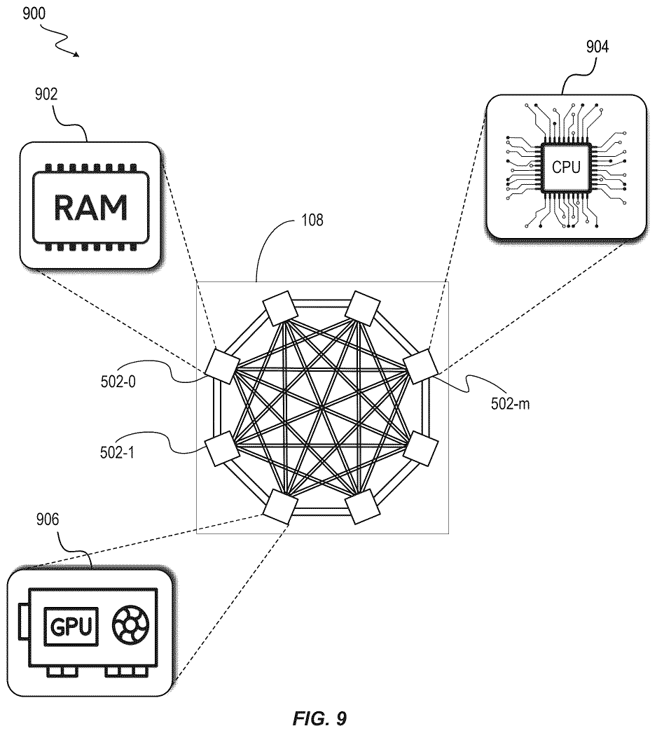

FIG. 9 is a schematic 900 of a group of chiplets including different types of chiplets in a wafer-level assembly of chiplets, in accordance with at least one example. In at least one example, chiplets 502-0, 502-1, . . . , 502-m are interconnected in a fully-connected topology. In at least one example, chiplets 502 are interconnected in a fat-tree topology. In at least one example, a group of chiplets 108 may have homogeneous integration. In at least one example, a chiplet 502-0 in the group of chiplets 108 is directly connected to other chiplets 502-0, 502-1, . . . , 502-m within the group of chiplets 108. In at least one example, chiplets 502 can be connected in the fat-tree topology, wherein the group of chiplets 108 may have homogeneous integration. Fat-tree topology may provide interconnections to one or more leaf-chiplets 604. In at least one example, chiplets 101 in the group of chiplets 108 are functionally similar. In at least one example, chiplets 504 in the group of chiplets 108 are fabricated using the same fabrication technology. In at least one example, chiplets 504 in the group of chiplets 108 are functionally different from each other. In at least one example, chiplets 504 in the group of chiplets 108 are fabricated using different fabrication technologies.

In at least one example, chiplets 504 are memory modules 902 connected in the fully-connected topology or the fat-tree topology. In at least one example, memory modules 902 may store data and instructions temporarily or permanently and may enable quick access to the information needed for operations. Memory modules 902 may include a random-access memory (RAM), a read-only memory (ROM), an erasable programmable read-only memory (EPROM), an electrically erasable programmable read-only memory (EEPROM), a dynamic random-access memory (DRAM), a static random-access memory (SRAM), a cache memory, etc. The choice of memory module 902 may not limit the disclosure.

In at least one example, chiplets 504 are GPUs 906 connected in a fully-connected topology or a fat-tree topology. GPUs 906 may handle and accelerate graphics rendering and parallel processing tasks. GPUs may excel in performing multiple simultaneous calculations, which makes them suitable for building a large scale data processing system.

In at least one example, chiplets 504 are CPUs 904 connected in the fully-connected topology or the fat-tree topology. CPUs 904 (that may have one or more processor cores) may process tasks, execute instructions, and manage operations of a computer. CPUs 904 may run the operating system or any other software. In at least one example, CPUs 904 are general purpose microprocessors, for example, Intel Core i9-13900K, AMD Ryzen 9 7950X, or Apple M2 Pro, etc. CPUs may be high-performance processors for gaming, content creation, or professional workloads. In at least one example, CPUs 904 are microcontrollers, for example, Microchip PIC16F84A, Atmel ATmega328, STMicroelectronics STM32F103, Texas Instruments MSP430G2553, etc.

In at least one example, group of chiplets 108 may have heterogeneous integration configured using a fully-connected topology or a fat-tree topology. Heterogeneous integration may combine multiple chiplets 502 having varying processing functions and fabrication technologies in one system, thereby allowing to synthesize specific complex functions, increase performance, and decrease cost per function. The encoding schemes described herein are applicable to group of chiplets 108 of FIG. 9.

Chiplets 504 may be a mix of CPU cores, memory modules, memory controllers, application-specific ICs (ASICs), field programmable gate arrays (FPGAs), GPUs, artificial intelligence (AI) accelerators, I/O controllers, filters, network flow processors (NFPs), serializers/deserializers (SerDes), reduced instruction set computers (RISCs), security modules, etc. In at least one example, a group of chiplets 108 may include one or more CPUs 904, multiple levels of cache, memory modules, or I/O controllers (e.g., as in accordance with the AMD 7000 Series Ryzen 7950X). In at least one example, the group of chiplets 108 comprises heterogeneous chiplets that can serve as application-specific ICs (ASICs), processor cores 404, field programmable gate arrays (FPGAs), serializers/deserializers (SerDes), network flow processors (NFPs), reduced instruction set computers (RISCs), or other such components.

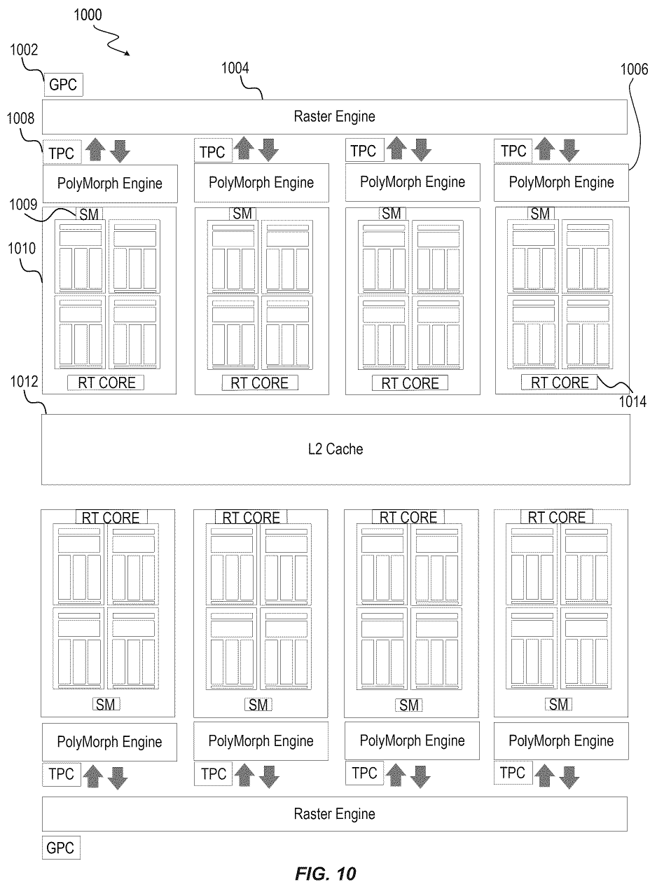

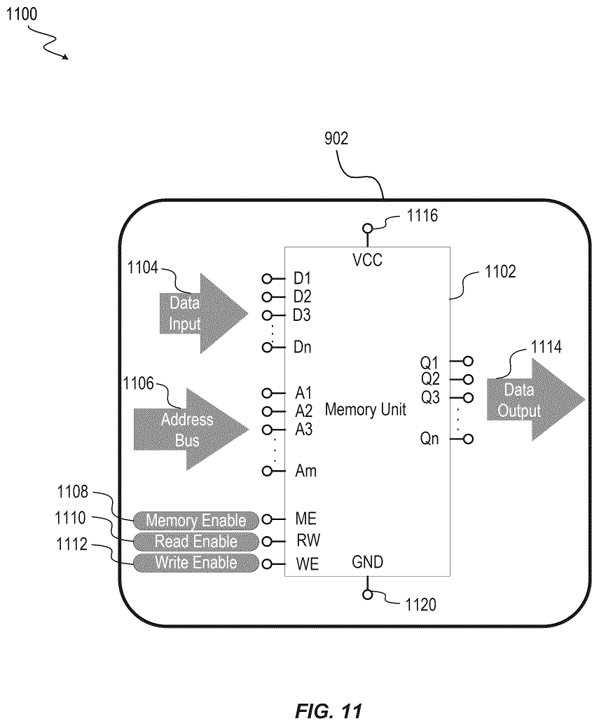

FIG. 10 is a schematic of a chiplet 1000 (e.g., GPUs 906 of FIG. 9) having functionality of a GPU, in accordance with at least one example. Chiplet 1000 may be one of the chiplets in a wafer-level assembly of chiplets. GPUs may handle parallel processing tasks efficiently, which may be suitable for many applications including graphics rendering, machine-learning (ML), natural language processing (NLP), or other computer-intensive applications. Chiplet 1000 may include a graphics processing cluster (GPC) 1002 which is a dedicated hardware block within a GPU. GPC 1002 may perform functions including computing, rasterization, shading, or texturing. In at least one example, chiplet 1000 includes GPC 1002 which includes texture processing clusters (TPC) 1008.

A TPC may include a streaming multiprocessor (SM) 1009 or a raster engine 1004. In at least one example, this architecture allows the GPUs to handle complex graphics tasks efficiently, which can be helpful in manufacturing processes or other professional applications. In at least one example, each GPC 1002 in a GPU has its own raster engine, ensuring parallel processing of graphics data. In at least one example, raster engine 1004 in a GPU is responsible for converting 3D models into 2D images that can be displayed on a display screen. In at least one example, raster engine 1004 processes the vertices of triangles that may determine the edges or how the edges can be displayed. Raster engine 1004 may remove non-visible pixels that may be behind other objects, thereby improving the rendering efficiency.

Texture Processor Cluster (TPC) 1008 may enhance the GPU's ability to handle complex graphics tasks. In at least one example, each TPC 1008 has multiple streaming multiprocessors (SMs) 1009 responsible for executing the core computational tasks. In at least one example, SMs 1009 can handle texture mapping, which may involve applying textures to 3D models. TPC 1008 may manage the coordination and control of the SMs or texture units within TPC 1008. TPC 1008 may be grouped into larger structures called graphics processing clusters (GPCs) 1002, which may further enhance the GPU's parallel processing capabilities. In at least one example, a polymorph engine 1006 in a GPU is a specialized unit which handles various stages of geometry processing. In at least one example, polymorph engine 1006 helps in transforming 3D models into a format that may be rasterized.

In at least one example, ray tracing cores (RT cores) 1014 in the GPUs accelerate ray tracing, a rendering technique that simulates the way light interacts with objects, to produce realistic images. In at least one example, ray tracing involves navigating a hierarchical structure to determine the objects to be checked for ray intersections. RT cores 1014 may check whether a ray intersects with triangles in a 3D model, which may be essential for accurate lighting or shadow calculations. In at least one example, an L2 cache 1012 in a GPU enhances performance or efficiency. L2 cache 1012 might store data that may be recently used by an L1 cache or resources that are shared by RT cores 1014. This helps in reducing the time it might take to access frequently used data. L2 cache 1012 may have slightly higher latency than the L1 cache but can still be very fast. In at least one example, L2 cache 1012 can act as an intermediary between the L1 cache or the main memory, can enhance the speed of data retrieval, or can reduce the need to access slower main memory. In at least one example, L2 cache 1012 is shared among all SMs in the GPU, thereby allowing efficient data sharing or coordination among processing units. L2 cache 1012 can mediate data transfers linking the GPU or the main memory. In at least one example, L2 cache 1012 helps manage the flow of data, thereby providing quick data access to RT cores 1014.

FIG. 11 is a schematic of a chiplet 1100 having functionality of a memory module, in accordance with at least one example. Chiplet 1100 may be one of chiplets 502 in a group of chiplets 108. In at least one example, chiplet 1100 includes a memory IC 1102 that is present within a memory module 902. In at least one example, memory IC 1102 comprises data input pins 1104, an address bus 1106, data output pins 1114, control signals, power supply pin (VCC) 1116, or ground (GND) 1120. Data input pins 1104 and data output pins 1114 may span from D1 to Dn. Address bus 1106 may span from A1 to Am. The control signals may include a memory enable 1108, read enable 1110, or write enable 1112. Memory enables 1108 may receive an enable signal that may activate or deactivate the memory IC 1102, thereby preventing unintentional data access. In at least one example, a pin memory enable 1108 can also be referred to as chip enable which indicates whether chiplet 1100 is in an active or inactive state. Read enable 1110, when active, may allow the data stored at a specified address in memory IC 1102 to be read and sent to data output pins 1114. Write enable 1112 can control when the data can be written at a specified address into memory IC 1102 through data input pins 1104. In at least one example, read enable 1110 and write enable 1112 could be merged as one, thereby combining the functionality of both control signals where a high signal may represent a data read request from memory IC 1102, and a low signal may represent a data write request into memory IC 1102.

In at least one example, a memory module 902 is a volatile memory that is used to store working data or machine code, for example, in a random-access memory (RAM). The RAM could allow the data to be read and written in the same amount of time irrespective of the physical location or the size of the data. In at least one example, memory module 902 is a non-volatile memory, e.g., a read-only memory (ROM), comprising data or instructions written permanently during the manufacturing process. The ROM may be useful in storing software or data that may rarely change during the entire life of a system. In some examples, the software on ROM can be referred to as firmware, such as basic input/output system (BIOS), router firmware, smart device operating system (OS), or the like. In at least one example, memory module 902 is an EROM (electrically rewritable ROM). The EROM is a variant of ROM that can be electrically erased and reprogrammed, thus allowing for updates during the life of the system. In at least one example, memory module 902 is an EEPROM (electrically erasable programmable ROM). The EEPROM may be a non-volatile memory that may be electrically erased or reprogrammed along with multiple write or erase cycles. One example of the EEPROM can have 10,000 to 100,000 write cycles. In at least one example, memory module 902 is a DRAM (Dynamic RAM). The DRAM may store each bit of data in a memory cell. The memory cell may comprise of a capacitor and a transistor. In some examples, the memory cell may comprise transistors. An external memory refresh circuitry may be used alongside the DRAM, to prevent gradual capacitor leaks, which may rewrite the data in the capacitors periodically. In at least one example, the DRAM and the memory refresh circuitry is present within memory module 902. In at least one example, memory module 902 is an SRAM (static RAM). The SRAM can store each bit of data without the need to refresh external memory circuitry. The SRAMs may be suitable for internal registers of the CPUs or caches. In at least one example, memory module 902 is an SDRAM (synchronous dynamic RAM). The SDRAM operations may be coordinated with an externally supplied clock signal, which may enhance the performance by processing data in an efficient manner.

In at least one example, one or more of the DRAMs or the SDRAMs can be integrated together in a memory module 902 with one or more buffers for driving the clock signal, the addresses, or the control signals. In at least one example, the memory module could be implemented using stacked memory packages. The stacked memory packages can have multiple memory chips or dies. Depending on the requirement, the stacked memory packages may operate synchronously or asynchronously.

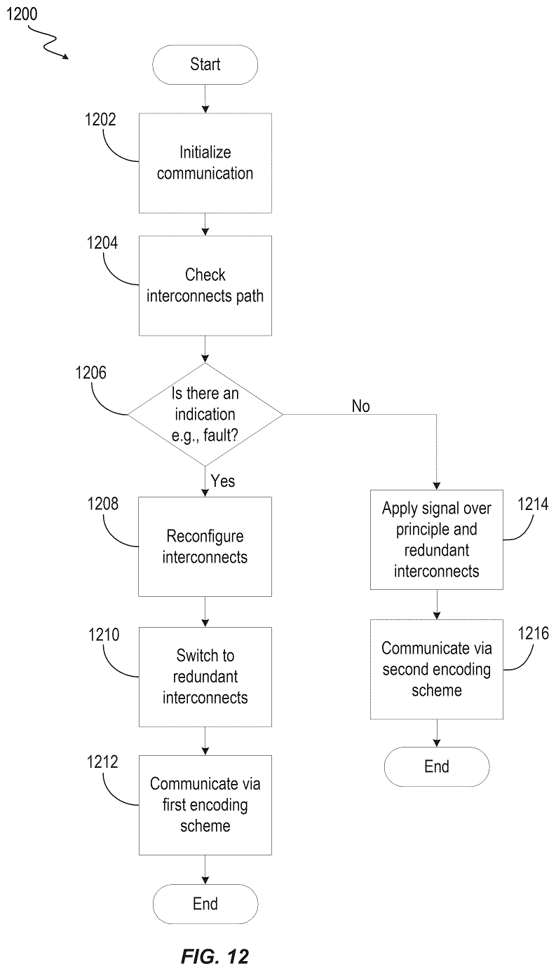

FIG. 12 is a flowchart 1200 of a method that detects an indication (e.g., fault) and switches an encoding scheme based on the indication, in accordance with at least one example. The various blocks of flowchart 1200 can be performed by hardware, software, or a combination of them. At block 1202, operating system or one or more logic units associated with chiplets or a group of chiplets 108 initializes communication protocols among the chiplets or group of chiplets. In at least one example, the operating system may configure parameters, e.g., bandwidth allocation or latency requirements.

At block 1204, the operating system may perform a thorough check of the communication pathways between chiplets or groups of chiplets 108. In at least one example, the operating system may examine the status of one or more set of interconnects and may also verify health of chiplets, e.g., assessing the signal integrity, bandwidth availability, and potential bottlenecks that can impact performance of a wafer-scale system. In at least one example, based on the assessment, an indication is generated.

At block 1206, the operating system evaluates the result from block 1204. Based on detection of the indication, the operating system makes decisions. In at least one example, the indication is a binary indication that may be generated based on the logic levels, which are either zero (0) or one (1). In at least one example, if a fault is detected, the operating system may signal the indication using a first logic level. In at least one example, the operating system may signal the indication using a second logic level, provided the first logic level is different from the second logic level. In at least one example, the indication may manifest as a change in the logic levels.

At block 1208, based on the indication of the first logic level (e.g., if a fault is present), the operating system reconfigures the interconnects or communication pathways to bypass the faulty chiplet. At block 1210, the operating system may switch to some of a set of redundant interconnects 112 to continue performing operations between groups of chiplets 108. The set of redundant interconnects 112 may be used alone where an indication of the first logic level is detected. At block 1212, the operating system may allow the groups of chiplets, having a fault, to signal it over the set of redundant interconnects 112 using a first encoding scheme. In at least one example, the first encoding scheme is a binary encoding scheme, which uses fewer bits by representing data as binary numbers, wherein all signal lines in the set of redundant interconnects 112 may be used to signal a communication. In at least one example, the traditional encoding scheme may use less signal lines and may have a high transition probability, which may not only consume more transition energy (e.g., to change states) but also more dynamic power. In at least one example, the first encoding scheme is wire efficient, e.g., the first encoding scheme makes use of less signal lines, but consumes more dynamic power.

At block 1214, based on indication of the second encoding scheme (e.g., if no fault is detected, or to switch to a turbo mode or the like), the operating system may apply signal over the set of principle interconnects 110 and the set of redundant interconnects 112. At block 1216, the operating system may signal using a second encoding scheme. In at least one example, the second encoding scheme is a one-hot encoding scheme that may signal using one-hot bit to reduce the transition probability and thus the transition energy. In at least one example, the second encoding scheme may have one bit that may be in an active state, all signal lines of the set of principle interconnects 110 and the set of redundant interconnects 112 may not be engaged. In at least one example, the second encoding scheme is wire inefficient, e.g., the second encoding scheme may use more channels or signal lines, but consume significantly less dynamic power.

Here, “device,” “node,” or “unit” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus, which comprises the device.

Here, “connected” or “connection” means a direct connection, such as electrical, mechanical, or magnetic connection between the things that are connected, without any intermediary devices.

Here, “coupled” means a direct or indirect connection, such as a direct electrical, mechanical, or magnetic connection between the things that are connected or an indirect connection, through one or more passive or active intermediary devices.

Here, “adjacent” here generally refers to a position of a thing being next to (e.g., immediately next to or close to with one or more things between them) or adjoining another thing (e.g., abutting it).

Here, “signal lines” or “wires” here generally refers to conductive pathways that facilitate transmission of data and control signals between different components (e.g., chiplets, processing cores or multi-core processors). Each signal line or wire can represent a single bit of information, or can be grouped together to form a bus to transmit multiple bits simultaneously.

Here, “circuit” or “module” may refer to one or more passive and/or active components that are arranged to cooperate with one another to provide a desired function.

Here, “signal” may refer to at least one current signal, voltage signal, magnetic signal, or data/clock signal. The meaning of “a,” “an,” and “the” include plural references. The meaning of “in” includes “in” and “on.”

Here, “analog signal” generally refers to any continuous signal for which the time varying feature (variable) of the signal is a representation of some other time varying quantity, i.e., analogous to another time varying signal.

Here, “digital signal” generally refers to a physical signal that is a representation of a sequence of discrete values (a quantified discrete-time signal), for example of an arbitrary bit stream, or of a digitized (sampled and analog-to-digital converted) analog signal.

Here, “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e., scaling down, or scaling up respectively) of a signal frequency relative to another parameter, for example, power supply level.

Here, “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

Unless otherwise specified the use of the ordinal adjectives “first,” “second,” and “third, etc., to describe a common object, merely indicate that different instances of like objects are being referred to and are not intended to imply that the objects so described must be in a given sequence, either temporally, spatially, in ranking or in any other manner.

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device.

Reference in the specification to “an example,” “one example,” “some examples,” or “other examples” means that a particular feature, structure, or characteristic described in connection with the examples is included in at least some examples, but not necessarily all examples. The various appearances of “an example,” “one example,” or “some examples” are not necessarily all referring to the same examples. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

Furthermore, the particular features, structures, functions, or characteristics may be combined in any suitable manner in one or more examples. For example, a first example may be combined with a second example anywhere the particular features, structures, functions, or characteristics associated with the two examples are not mutually exclusive.

While the disclosure has been described in conjunction with specific examples thereof, many alternatives, modifications and variations of such examples will be apparent to those of ordinary skill in the art in light of the foregoing description. The examples of the disclosure are intended to embrace all such alternatives, modifications, and variations as to fall within the broad scope of the appended claims.

In addition, well-known power/ground connections to IC chips and other components may or may not be shown within the presented figures, for simplicity of illustration and discussion, and so as not to obscure the disclosure. Further, arrangements may be shown in block diagram form to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth to describe examples of the disclosure, it should be apparent to one skilled in the art that the disclosure can be practiced without, or with variation of, these specific details. The description is thus to be regarded as illustrative instead of limiting.

The structures of various examples described herein can also be described as method(s) of forming those structures or apparatuses, and method(s) of operation of these structures or apparatuses. The following examples are provided that illustrate the various examples of the disclosure. The examples can be combined with other examples. As such, various examples can be combined with other examples without changing the scope of the invention.

Example 1 is an apparatus comprising: a plurality of processors including a first processor and a second processor; and a plurality of interconnects coupled to the plurality of processors, wherein the plurality of interconnects further includes a plurality of principle interconnects and a plurality of redundant interconnects, wherein the plurality of interconnects is to transmit signals between the first processor and the second processor using one or more encoding schemes based on an indication from one or more logics associated with the plurality of processors, wherein the one or more encoding schemes includes a first encoding scheme and a second encoding scheme, wherein the first encoding scheme applies signals over some but not all of the plurality of redundant interconnects based on a first logic level of the indication, and wherein the second encoding scheme applies signals over the plurality of principle interconnects and the plurality of redundant interconnects based on a second logic level of the indication, and wherein the first logic level is different from the second logic level.

Example 2 is an apparatus according to any example herein, in particular example 1, wherein the one of more logics are an operating system that execute on the plurality of processors.

Example 3 is an apparatus according to any example herein, in particular example 1, wherein the one or more logics, based on the first logic level of the indication, reconfigures the plurality of redundant interconnects to reclaim a logical configuration of the plurality of processors, and wherein the logical configuration is one of a fully-connected configuration, a fat-tree configuration, or a mesh configuration.

Example 4 is an apparatus according to any example herein, in particular example 1, wherein the first logic level indicates presence of a fault in at least one processor of the plurality of processors.

Example 5 is an apparatus according to any example herein, in particular example 1, wherein the second logic level indicates absence of a fault in the plurality of processors.

Example 6 is an apparatus according to any example herein, in particular example 1, wherein the plurality of processors is a plurality of dies.

Example 7 is an apparatus according to any example herein, in particular example 6,wherein the plurality of dies is coupled in a fully-connected configuration, a fat-tree configuration, or a mesh configuration.

Example 8 is an apparatus according to any example herein, in particular example 1, wherein the plurality of processors is one or more processor cores.

Example 9 is an apparatus according to any example herein, in particular example 8,wherein the one or more processor cores is coupled in a fully-connected configuration, a fat-tree configuration, or a mesh configuration.

Example 10 is an apparatus according to any example herein, in particular example 1, wherein the plurality of processors is a plurality of chips, each with multiple processor cores.

Example 11 is an apparatus according to any example herein, in particular example 10, wherein the plurality of chips is coupled in a fully-connected configuration, a fat-tree configuration, or a mesh configuration.

Example 12 is an apparatus according to any example herein, in particular example 1, wherein the second encoding scheme is a one-hot encoding scheme.

Example 13 is an apparatus comprising: one or more encoders to transmit a first set of signals on some but not all of the plurality of redundant interconnects based on a first logic level of an indication from one or more logic circuits, and to transmit a second set of signals on the set of principle interconnects and the set of redundant interconnects based on a second logic level of the indication, wherein the second logic level is different than the first logic level, wherein the set of principle interconnects and the set of redundant interconnects are connected between a first processor and a second processor.

Example 14 is an apparatus according to any example herein, in particular example 13, wherein the first logic level indicates presence of a fault in at least one of the first processor or the second processor, and wherein the second logic level indicates absence of a fault in the first processor and the second processor.

Example 15 is an apparatus according to any example herein, in particular example 13, wherein the second set of signals is based on a one-hot encoding scheme.

Example 16 is a wafer-level assembly of chiplets comprising: a plurality of groups of chiplets including a first group of chiplets, and a second group of chiplets, wherein the first group of chiplets is organized as a first fully-connected configuration, and wherein the second group of chiplets is organized as a second fully-connected configuration; and a plurality of interconnects including a first set of interconnects and a second set of interconnects, wherein the first set of interconnects couples a first chiplet of the first group of chiplets with a first chiplet of the second group of chiplets, wherein the second set of interconnects couples a second chiplet of the first group of chiplets with a second chiplet of the second group of chiplets, wherein the plurality of interconnects is arranged in a mesh configuration, wherein the first set of interconnects includes a first set of principle interconnects and a first set of redundant interconnects, wherein the second set of interconnects includes a second set of principle interconnects and a second set of redundant interconnects, wherein the plurality of interconnects is to transmit signals between the first chiplet of the first group of chiplets and the first chiplet of the second group of chiplets using one or more encoding schemes based on an indication from one or more logics associated with the plurality of groups of chiplets, wherein the one or more encoding schemes includes a first encoding scheme and a second encoding scheme, wherein the first encoding scheme applies signals over some but not all of the first and second sets of redundant interconnects based on a first logic level of the indication, and wherein the second encoding scheme applies signals over the first and second sets of principle interconnects and the first and second sets of redundant interconnects based on a second logic level of the indication, and wherein the first logic level is different from the second logic level.

Example 17 is a wafer-level assembly of chiplets according to any example herein, in particular example 16, further comprising a substrate, wherein the plurality of groups of chiplets is on the substrate, and wherein the substrate includes a redistribution layer.

Example 18 is a wafer-level assembly of chiplets according to any example herein, in particular example 17, wherein the plurality of interconnects is in the substrate, wherein the substrate includes a bridge die embedded in a core of the substrate which is at least partially under a first group of chiplets and a second group of chiplets, and wherein the plurality of interconnects is embedded in the bridge die.

Example 19 is a wafer-level assembly of chiplets according to any example herein, in particular example 17, wherein the second encoding scheme is a one-hot encoding scheme.

Example 20 is a wafer-level assembly of chiplets according to any example herein, in particular example 16, wherein the one of more logics are an operating system that execute on the plurality of groups of chiplets.

Example 21 is a wafer-level assembly of chiplets according to any example herein, in particular example 16, wherein the one or more logics, based on the first logic level of the indication, reconfigures the first and second sets of redundant interconnects to reclaim a logical configuration of the plurality of groups of chiplets, and wherein the logical configuration is one of a fully-connected configuration, a fat-tree configuration, or a mesh configuration.

Example 22 is a wafer-level assembly of chiplets according to any example herein, in particular example 16, wherein the first logic level indicates presence of a fault in at least one of the first chiplet of the first group of chiplets and the first chiplet of the second group of chiplets, wherein the second logic level indicates absence of a fault in the plurality of groups of chiplets.

Example 23 is a wafer-level assembly of chiplets according to any example herein, in particular example 16, wherein the plurality of groups of chiplets are arranged in a torus configuration.

Example 24 is a wafer-level assembly of chiplets comprising: a plurality of groups of chiplets including a first group of chiplets, a second group of chiplets, wherein the first group of chiplets is organized as a first fat-tree configuration, and wherein the second group of chiplets is organized as a second fat-tree configuration; and a plurality of interconnects including a first set of interconnects and a second set of interconnects, wherein the first set of interconnects couples a first chiplet of the first group of chiplets with a first chiplet of the second group of chiplets, wherein the second set of interconnects couples a second chiplet of the first group of chiplets with a second chiplet of the second group of chiplets, wherein the plurality of interconnects is arranged in a mesh configuration, wherein the first set of interconnects includes a first set of principle interconnects and a first set of redundant interconnects, wherein the second set of interconnects includes a second set of principle interconnects and a second set of redundant interconnects, wherein the plurality of interconnects is to transmit signals between the first chiplet of the first group of chiplets and the first chiplet of the second group of chiplets using one or more encoding schemes based on an indication from one or more logics associated with the plurality of groups of chiplets, wherein the one or more encoding schemes includes a first encoding scheme and a second encoding scheme, wherein the first encoding scheme applies signals over some but not all of the first and second sets of redundant interconnects based on a first logic level of the indication, and wherein the second encoding scheme applies signals over the first and second sets of principle interconnects and the first and second sets of redundant interconnects based on a second logic level of the indication, and wherein the first logic level is different from the second logic level.

Example 25 is a wafer-level assembly of chiplets according to any example herein, in particular example 24, wherein the second encoding scheme is a one-hot encoding scheme.

What is claimed is:

1. An apparatus comprising:
a plurality of processors including a first processor and a second processor; and
a plurality of interconnects coupled to the plurality of processors, wherein the plurality of interconnects further includes a plurality of principle interconnects and a plurality of redundant interconnects, wherein the plurality of interconnects is to transmit signals between the first processor and the second processor using one or more encoding schemes based on an indication from one or more logics associated with the plurality of processors, wherein the one or more encoding schemes includes a first encoding scheme and a second encoding scheme, wherein the first encoding scheme applies signals over some but not all of the plurality of redundant interconnects based on a first logic level of the indication, and wherein the second encoding scheme applies signals over the plurality of principle interconnects and the plurality of redundant interconnects based on a second logic level of the indication, and wherein the first logic level is different from the second logic level.

2. The apparatus of claim 1, wherein the one of more logics are an operating system that execute on the plurality of processors.

3. The apparatus of claim 1, wherein the one or more logics, based on the first logic level of the indication, reconfigures the plurality of redundant interconnects to reclaim a logical configuration of the plurality of processors, and wherein the logical configuration is one of a fully-connected configuration, a fat-tree configuration, or a mesh configuration.

4. The apparatus of claim 1, wherein the first logic level indicates presence of a fault in at least one processor of the plurality of processors.

5. The apparatus of claim 1, wherein the second logic level indicates absence of a fault in the plurality of processors.

6. The apparatus of claim 1, wherein the plurality of processors is a plurality of dies.

7. The apparatus of claim 6, wherein the plurality of dies is coupled in a fully-connected configuration, a fat-tree configuration, or a mesh configuration.

8. The apparatus of claim 1, wherein the plurality of processors is one or more processor cores.

9. The apparatus of claim 8, wherein the one or more processor cores is coupled in a fully-connected configuration, a fat-tree configuration, or a mesh configuration.

10. The apparatus of claim 1, wherein the plurality of processors is a plurality of chips, each with multiple processor cores.

11. The apparatus of claim 10, wherein the plurality of chips is coupled in a fully-connected configuration, a fat-tree configuration, or a mesh configuration.

12. The apparatus of claim 1, wherein the second encoding scheme is a one-hot encoding scheme.

13. An apparatus comprising:
one or more encoders to transmit a first set of signals on some but not all of plurality of redundant interconnects based on a first logic level of an indication from one or more logic circuits, and to transmit a second set of signals on a set of principle interconnects and the plurality of redundant interconnects based on a second logic level of the indication, wherein the second logic level is different than the first logic level, wherein the set of principle interconnects and the plurality of redundant interconnects are connected between a first processor and a second processor.

14. The apparatus of claim 13, wherein the first logic level indicates presence of a fault in at least one of the first processor or the second processor, and wherein the second logic level indicates absence of a fault in the first processor and the second processor.

15. The apparatus of claim 13, wherein the second set of signals is based on a one-hot encoding scheme.

16. A wafer-level assembly of chiplets comprising:
a plurality of groups of chiplets including a first group of chiplets, and a second group of chiplets, wherein the first group of chiplets is organized as a first fully-connected configuration, and wherein the second group of chiplets is organized as a second fully-connected configuration; and
a plurality of interconnects including a first set of interconnects and a second set of interconnects, wherein the first set of interconnects couples a first chiplet of the first group of chiplets with a first chiplet of the second group of chiplets, wherein the second set of interconnects couples a second chiplet of the first group of chiplets with a second chiplet of the second group of chiplets, wherein the plurality of interconnects is arranged in a mesh configuration, wherein the first set of interconnects includes a first set of principle interconnects and a first set of redundant interconnects, wherein the second set of interconnects includes a second set of principle interconnects and a second set of redundant interconnects,
wherein the plurality of interconnects is to transmit signals between the first chiplet of the first group of chiplets and the first chiplet of the second group of chiplets using one or more encoding schemes based on an indication from one or more logics associated with the plurality of groups of chiplets, wherein the one or more encoding schemes includes a first encoding scheme and a second encoding scheme, wherein the first encoding scheme applies signals over some but not all of the first and second sets of redundant interconnects based on a first logic level of the indication, and wherein the second encoding scheme applies signals over the first and second sets of principle interconnects and the first and second sets of redundant interconnects based on a second logic level of the indication, and wherein the first logic level is different from the second logic level.

17. The wafer-level assembly of chiplets of claim 16 further comprising a substrate, wherein the plurality of groups of chiplets is on the substrate, and wherein the substrate includes a redistribution layer.

18. The wafer-level assembly of chiplets of claim 17, wherein the plurality of interconnects is in the substrate, wherein the substrate includes a bridge die embedded in a core of the substrate which is at least partially under a first group of chiplets and a second group of chiplets, and wherein the plurality of interconnects is embedded in the bridge die.

19. The wafer-level assembly of chiplets of claim 16, wherein the second encoding scheme is a one-hot encoding scheme.

20. The wafer-level assembly of chiplets of claim 16, wherein the one of more logics are an operating system that execute on the plurality of groups of chiplets.

21. The wafer-level assembly of chiplets of claim 16, wherein the one or more logics, based on the first logic level of the indication, reconfigures the first and second sets of redundant interconnects to reclaim a logical configuration of the plurality of groups of chiplets, and wherein the logical configuration is one of a fully-connected configuration, a fat-tree configuration, or a mesh configuration.

22. The wafer-level assembly of chiplets of claim 16, wherein the first logic level indicates presence of a fault in at least one of the first chiplet of the first group of chiplets and the first chiplet of the second group of chiplets, wherein the second logic level indicates absence of a fault in the plurality of groups of chiplets.

23. The wafer-level assembly of chiplets of claim 16, wherein the plurality of groups of chiplets are arranged in a torus configuration.

24. A wafer-level assembly of chiplets comprising:
a plurality of groups of chiplets including a first group of chiplets, a second group of chiplets, wherein the first group of chiplets is organized as a first fat-tree configuration, and wherein the second group of chiplets is organized as a second fat-tree configuration; and
a plurality of interconnects including a first set of interconnects and a second set of interconnects, wherein the first set of interconnects couples a first chiplet of the first group of chiplets with a first chiplet of the second group of chiplets, wherein the second set of interconnects couples a second chiplet of the first group of chiplets with a second chiplet of the second group of chiplets, wherein the plurality of interconnects is arranged in a mesh configuration, wherein the first set of interconnects includes a first set of principle interconnects and a first set of redundant interconnects, wherein the second set of interconnects includes a second set of principle interconnects and a second set of redundant interconnects,
wherein the plurality of interconnects is to transmit signals between the first chiplet of the first group of chiplets and the first chiplet of the second group of chiplets using one or more encoding schemes based on an indication from one or more logics associated with the plurality of groups of chiplets, wherein the one or more encoding schemes includes a first encoding scheme and a second encoding scheme, wherein the first encoding scheme applies signals over some but not all of the first and second sets of redundant interconnects based on a first logic level of the indication, and wherein the second encoding scheme applies signals over the first and second sets of principle interconnects and the first and second sets of redundant interconnects based on a second logic level of the indication, and wherein the first logic level is different from the second logic level.

25. The wafer-level assembly of chiplets of claim 24, wherein the second encoding scheme is a one-hot encoding scheme.
